(19) United States
(12) Patent Application Publication
(10) Pub. No.: US 2025/0269878 A1
(43) Pub. Date: Aug. 28, 2025

(54) Systems and Methods for Optimized Multi-Agent Routing Between Nodes

(71) Applicant: Aurora Operations, Inc., Pittsburgh, PA (US)

(72) Inventors: Quinlan Sykora, Toronto (CA); Mengye Ren, Toronto (CA); Raquel Urtasun, Toronto (CA)

(21) Appl. No.: 19/193,414

(22) Filed: Apr. 29, 2025

Related U.S. Application Data
(63) Continuation of application No. 17/032,509, filed on Sep. 25, 2020.
(60) Provisional application No. 63/023,483, filed on May 12, 2020.
(60) Provisional application No. 62/971,422, filed on Feb. 7, 2020.

(51) Int. Cl. B60W 60/00; G06F 18/214; G06F 18/25; G06N 3/04; G06N 3/08; G06V 10/44; G06V 10/82

(52) U.S. Cl. CPC B60W 60/0021; G06F 18/214; G06F 18/25; G06N 3/04; G06N 3/08; G06V 10/454; G06V 10/82

(57) ABSTRACT

Systems and methods described herein can provide for: obtaining, from a remote autonomous vehicle computing system, an incoming communication vector descriptive of a local environmental condition of a remote autonomous vehicle; inputting the incoming communication vector into a value iteration graph neural network of an autonomous vehicle; generating, by the value iteration graph neural network, transportation segment navigation instructions identifying a target transportation segment to navigate the autonomous vehicle to; generating a motion plan through an environment of the autonomous vehicle; and controlling the autonomous vehicle by one or more vehicle control systems based on the motion plan.

### RELATED APPLICATION

The present application is based on and claims benefit of U.S. Provisional Patent Application No. 63/023,483 having a filing date of May 12, 2020, U.S. Provisional Patent Application No. 62/971,422 having a filing date of Feb. 7, 2020, and U.S. patent application Ser. No. 17/032,509 having a filing date of Sep. 25, 2020, which are incorporated by reference herein.

### FIELD

The present disclosure relates generally to multi-agent routing methods. In particular, the present disclosure is directed to systems and methods for utilizing distributed, decentralized graph networks to route multiple agents between nodes.

### BACKGROUND

The routing of multiple agents through node networks has proven to be a computationally complex problem. One example of this problem is routing multiple vehicles (e.g., autonomous vehicles) through a transportation network represented using nodes of a graph.

Conventional methods for multi-agent routing are generally constrained to offline, centralized implementations due to the inherent computational complexity of routing agents. As such, these conventional methods are unable to utilize distributed, decentralized communication between agents to iteratively optimize routing solutions based on agent observations.

### SUMMARY

Aspects and advantages of embodiments of the present disclosure will be set forth in part in the following description, or may be learned from the description, or may be learned through practice of the embodiments.

One example aspect of the present disclosure is directed to an autonomous vehicle computing system. The autonomous vehicle computing system can include one or more processors. The autonomous vehicle computing system can include a value iteration graph neural network comprising a plurality of nodes that respectively correspond to a plurality of segments of a transportation network, wherein a plurality of node feature vectors respectively correspond to the plurality of nodes. The autonomous vehicle computing system can include one or more non-transitory computer-readable media that collectively store instructions that, when executed by the one or more processors, cause the computing system to perform operations. The operations can include determining, using the value iteration graph neural network, a first plurality of updated node feature vectors and a first plurality of node values respectively for the plurality of nodes. The operations can include navigating the vehicle to a first segment of the transportation network based at least in part on the first plurality of node values. The operations can include receiving, from one or more remote autonomous vehicle computing systems of one or more other vehicles, one or more incoming communication vectors. The operations can include inputting the one or more incoming communication vectors and the plurality of updated node feature vectors to the value iteration graph neural network to obtain a second plurality of updated node feature vectors and a second plurality of node values. The operations can include navigating the vehicle to a second segment of the transportation network based at least in part on the second plurality of node values.

Another example aspect of the present disclosure is directed to a computer-implemented method for generating, for a vehicle, a route through a transportation network comprising a plurality of segments. The method can include, for one or more iterations, receiving, by a vehicle computing system comprising one or more computing devices, one or more sets of agent attention data from one or more additional vehicle computing systems that are respectively currently located at one or more other segments of the transportation network. The method can include, for one or more iterations, inputting, by the vehicle computing system, the one or more sets of agent attention data into a value iteration graph neural network that comprises a plurality of nodes that respectively correspond to the plurality of segments of the transportation network, wherein each node of the value iteration graph neural network is configured to receive the agent attention data associated with the corresponding segment. The method can include, for one or more iterations, receiving, by the vehicle computing system, a plurality of node values respectively for the plurality of segments as an output of the value iteration graph neural network. The method can include, for one or more iterations, selecting, by the vehicle computing system, a next segment to include in the route for the vehicle based at least in part on the plurality of node values.

Another example aspect of the present disclosure is directed to a computer-implemented method to train a network to generate a route for an autonomous vehicle through a transportation network comprising a plurality of segments. The method can include, for one or more iterations, receiving, by a computing system comprising one or more computing devices, one or more sets of agent attention training data from one or more training computing systems that are respectively currently located at one or more other segments of the transportation network. The method can include, for one or more iterations, inputting, by the computing system, the one or more sets of agent attention training data into a value iteration graph neural network that comprises a plurality of nodes that respectively correspond to the plurality of segments of the transportation network, wherein each node of the value iteration graph neural network is configured to receive the attention data associated with the corresponding segment. The method can include, for one or more iterations, receiving, by the computing system, a plurality of node values respectively for the plurality of segments as an output of the value iteration graph neural network. The method can include, for one or more iterations, selecting, by the computing system, a next segment to include in the route for the autonomous vehicle based at least in part on the plurality of node values. The method can include, for one or more iterations, evaluating, by the computing system, a loss function that evaluates a difference between the next segment and a ground truth associated with the agent attention training data. The method can include, for one or more iterations, modifying, by the computing system, one or more parameter values of the value iteration graph neural network based at least in part on the loss function.

For example, in an aspect, the present disclosure provides a computer-implemented method. The method includes obtaining, from a remote autonomous vehicle computing system, an incoming communication vector descriptive of a local environmental condition of a remote autonomous vehicle. The method includes inputting the incoming communication vector into a value iteration graph neural network of an autonomous vehicle. The method includes generating, by the value iteration graph neural network, transportation segment navigation instructions identifying a target transportation segment to navigate the autonomous vehicle to. The method includes generating a motion plan through an environment of the autonomous vehicle. The method includes controlling the autonomous vehicle by one or more vehicle control systems based on the motion plan.

In some implementations, the method further includes generating an outgoing communication vector descriptive of one or more node values of the value iteration graph neural network.

In some implementations, the outgoing communication vector further includes information included in the incoming communication vector.

In some implementations, the remote autonomous vehicle includes a second value iteration graph neural network configured to receive the outgoing communication vector.

In some implementations, the method further includes: obtaining, from a plurality of additional remote autonomous vehicle computing systems, a plurality of additional incoming communication vectors respectively descriptive of respective local environmental conditions of a plurality of additional remote autonomous vehicles respective to the plurality of additional remote autonomous vehicle computing systems; and inputting the plurality of additional incoming communication vectors into the value iteration graph neural network.

In some implementations, the method further includes: aggregating, by a machine-learned aggregation layer, the incoming communication vector and the plurality of additional incoming communication vectors to generate an aggregated incoming communication vector; and inputting the aggregated incoming communication vector into the value iteration graph neural network.

In some implementations, the machine-learned aggregation layer includes attentional actor weights respectively associated with the remote autonomous vehicle and respectively associated with the plurality of additional remote autonomous vehicles.

In some implementations, the machine-learned aggregation layer includes an adjacency matrix.

In some implementations, the value iteration graph neural network includes a map graph, the map graph including one or more nodes corresponding to one or more transportation segments of a transportation segment network.

In some implementations, the autonomous vehicle is positioned at a first segment of the one or more transportation segments of the transportation segment network, and wherein the remote autonomous vehicle is positioned at a second segment of the one or more transportation segments of the transportation segment network.

In some implementations, the method further includes: evaluating a value function of a plurality of nodes of the value iteration graph neural network; and identifying a node of the plurality of nodes of the value iteration graph neural network having a maximum value of the value function respective to the node.

In some implementations, the method further includes updating, based on the incoming communication vector, the value iteration graph neural network.

In some implementations, the method further includes updating the value iteration graph neural network based on observational data of the autonomous vehicle. 14.

For example, in an aspect, the present disclosure provides an autonomous vehicle (AV) computing system. The AV computing system includes one or more processors and one or more tangible, non-transitory, computer-readable media that store instructions that are executable by the one or more processors to perform operations. The operations include obtaining, from a remote autonomous vehicle computing system, an incoming communication vector descriptive of a local environmental condition of a remote autonomous vehicle. The operations include inputting the incoming communication vector into a value iteration graph neural network of an autonomous vehicle. The operations include generating, by the value iteration graph neural network, transportation segment navigation instructions identifying a target transportation segment to navigate the autonomous vehicle to. The operations include generating a motion plan through an environment of the autonomous vehicle. The operations include controlling the autonomous vehicle by one or more vehicle control systems based on the motion plan.

In some implementations, the operations further include generating an outgoing communication vector descriptive of one or more node values of the value iteration graph neural network.

In some implementations, the operations further include: obtaining, from a plurality of additional remote autonomous vehicle computing systems, a plurality of additional incoming communication vectors respectively descriptive of respective local environmental conditions of a plurality of additional remote autonomous vehicles respective to the plurality of additional remote autonomous vehicle computing systems; and inputting the plurality of additional incoming communication vectors into the value iteration graph neural network.

In some implementations, the operations further include: aggregating, by a machine-learned aggregation layer, the incoming communication vector and the plurality of additional incoming communication vectors to generate an aggregated incoming communication vector; and inputting the aggregated incoming communication vector into the value iteration graph neural network.

In some implementations, the value iteration graph neural network includes a map graph, the map graph including one or more nodes corresponding to one or more transportation segments of a transportation segment network.

In some implementations, the operations further include updating, based on the incoming communication vector, the value iteration graph neural network.

For example, in an aspect, the present disclosure provides one or more processors and one or more tangible, non-transitory, computer-readable media that store instructions that are executable by the one or more processors to perform operations. The operations include obtaining, from a remote autonomous vehicle computing system, an incoming communication vector descriptive of a local environmental condition of a remote autonomous vehicle. The operations include inputting the incoming communication vector into a graph neural network structured to update node feature vectors of a plurality of nodes that respectively correspond to a plurality of segments of a transportation network and to select, based on the updated node feature vectors, a target transportation segment of the plurality of segments. The operations include generating, by the neural network, transportation segment navigation instructions identifying the target transportation segment to navigate the autonomous vehicle to. The operations include generating a motion plan through an environment of the autonomous vehicle. The operations include controlling the autonomous vehicle by one or more vehicle control systems based on the motion plan.

Other example aspects of the present disclosure are directed to systems, methods, vehicles, apparatuses, tangible, non-transitory computer-readable media, and memory devices for controlling autonomous vehicles.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system overview including an autonomous vehicle according to example embodiments of the present disclosure;

FIG. 2 is a block diagram depicting a process for selecting an optimal transportation segment node based on incoming communication vectors according to example embodiments of the present disclosure;

FIG. 3 depicts a flowchart illustrating an example method for facilitating incoming and outgoing communication vectors across a plurality of autonomous vehicle computing systems according to example embodiments of the present disclosure;

FIG. 4 depicts a block diagram depicting an example architecture and implementation for a value iteration graph neural network according to example embodiments of the present disclosure;

FIG. 5 depicts a flowchart for selecting and navigating to optimal transportation segment nodes based on incoming communication vectors according to example embodiments of the present disclosure;

FIG. 6 depicts a flowchart for selecting an optimal transportation segment node based on incoming communication vectors according to example embodiments of the present disclosure;

FIG. 7 depicts a flowchart for training a value iteration graph neural network according to example embodiments of the present disclosure;

FIG. 8 depicts an example distributed computing system architecture according to example embodiments of the present disclosure according to example embodiments of the present disclosure; and

FIG. 9 depicts example system units for performing operations and functions according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to improved systems and methods for routing multiple agents in a coordinated manner. More particularly, the example systems and methods described herein can utilize distributed, decentralized graph networks to optimally route agents (e.g., autonomous vehicles, etc.) between nodes (e.g., transportation segments of a transportation network, etc.). For example, an autonomous vehicle computing system can include a graph network (e.g., a value iteration graph neural network, etc.) that includes a plurality of nodes. These nodes can represent transportation segments of a transportation network (e.g., road segments in a city, etc.). The graph neural network can be used to update the nodes of the graph (e.g., node feature values, etc.) based on communication vectors from other remote autonomous vehicles traversing the same transportation network. As an example, a remote autonomous vehicle can observe data describing node features (e.g., the amount of traffic in a transportation segment) and send the observational data to the autonomous vehicle computing system in a communication vector. The communication vector can be input to the graph neural network to update the features of the nodes. Based on the features of the nodes (e.g., a feature-based optimal node value), the autonomous vehicle can select an optimal node to navigate to. Further, the autonomous vehicle can also send its own communication vector to the remote autonomous vehicle communicating relevant node features. Thus, in such fashion, the present disclosure provides techniques to more accurately and efficiently plan transportation routes for autonomous vehicles in a transportation network by facilitating communication of real-time features and conditions of transportation segments of the network, allowing autonomous vehicles to avoid sub-optimal segments (e.g., heavy traffic, etc.).

Routing multiple autonomous agents to perform a task is a challenging problem that is generally considered computationally complex. More particularly, the dynamic routing of multiple autonomous vehicles while accounting for real-life variables has generally been considered to be amongst the most computationally complex problems to solve (e.g., NP-hard). Previous solutions to this problem, while possessing NP-hard complexity, have also generally been implemented in an offline environment, and therefore have limited applicability to distributed autonomous driving scenarios that require communication between agents. While more recent solutions have attempted to facilitate communication to agents from a central system, such approaches suffer from a lack of both efficiency and the redundancy provided by decentralization.

In accordance with example embodiments of the present disclosure, a decentralized, distributed route planning solution is provided. More particularly, a vehicle computing system (e.g., an autonomous vehicle computing system, a non-autonomous vehicle computing system, etc.) can include a value iteration graph neural network. The value iteration graph neural network can include a plurality of nodes that respectively correspond to a plurality of segments of a transportation network. A plurality of node feature vectors can be respectively associated with the plurality of nodes. The vehicle computing system can use the value iteration graph neural network to update the node feature vectors and determine a first plurality of node values for the plurality of nodes. Based on the first plurality of node values, the autonomous vehicle can select a first segment of the transportation network to which to navigate.

Additionally, the autonomous vehicle computing system can receive, from one or more remote autonomous vehicle computing systems, one or more incoming communication vectors (e.g., based on remote node values, feature vectors, etc.). The autonomous vehicle computing system can input the incoming communication vector(s) and the plurality of updated node feature vectors to the value iteration graph neural network to obtain a second plurality of updated node feature vectors and a second plurality of node values. Based on the second plurality of node vectors, the autonomous vehicle computing system can select a second segment of the transportation network to which to navigate. In such fashion, the autonomous vehicle computing system can receive communication vectors and update the nodes of the value iteration graph neural network, therefore iteratively optimizing the map graph with real-time information to more efficiently and optimally navigate a route through the transportation network.

In some implementations, navigating to the first segment of the transportation network can include communicating an outgoing communication vector to the remote autonomous vehicle computing system(s). The outgoing communication vector can be based at least in part on the first plurality of updated node feature vectors. As an example, the autonomous vehicle computing system can update the node feature vectors based on its own observational data and a number of incoming communication vector(s). This information can be included in the outgoing communication vector. In such fashion, the local observations and/or computations of the autonomous vehicle computing system can be communicated to other remote vehicles, therefore increasing efficiency among the vehicles.

In some implementations, using the value iteration graph neural network to determine the first plurality of updated node feature vectors and the first plurality of node values can include using a machine-learned attention layer of the value iteration graph neural network. The machine-learned attention layer can generate a plurality of attentional weights respectively associated with the plurality of nodes (e.g., based on a distance from the vehicle, spatial relationships between the segments, etc.). As one example, the autonomous vehicle computing system can determine a dense adjacency matrix that describes a distance between each of the plurality of nodes, and can generate an attention matrix based on the dense adjacency matrix and the plurality of attentional weights. Based on the attention matrix, the autonomous vehicle computing system can update the plurality of node feature vectors (e.g., across one or more iterations) to obtain the first plurality of updated node feature vectors and the first plurality of node values (e.g., respectively for the plurality of nodes, etc.).

In some implementations, the node feature vectors can describe one or more features of the node. As an example, the features can include a number of times the node has been traversed. As another example, the features can include a distance from the autonomous vehicle to the node. As yet another example, the features can include an amount of vehicle traffic associated with the node or a number of nodes adjacent to the node. Other arbitrary features descriptive of conditions at or characteristics of the segments can be used.

In some implementations, the autonomous vehicle computing system can use a machine-learned attention aggregation layer to process the incoming communication vectors. More particularly, a machine-learned attention aggregation layer of the value iteration graph neural network can be used to generate an aggregated incoming communication vector based on attentional actor weights associated with each of the one or more remote autonomous vehicle computing systems. The one or more communication vectors can be aggregated such that the aggregated communication vector provides scalar node values for each node of the value iteration graph neural network. In such fashion, the aggregated incoming communication vector can easily facilitate updating of the nodes.

In some implementations, the communication vectors can each include one or more feature vector values and a key value. The machine-learned aggregation layer of the value iteration graph neural network can be configured to transform each of the one or more incoming communication vectors into a respective query vector and value vector. Further, the machine-learned aggregation layer can aggregate the one or more incoming communication vectors based on the respective query vectors, value vectors, and key values of the one or more incoming communication vectors. In such fashion, the attentional weights can be used to aggregate the incoming communication vectors.

In some implementations, the value iteration graph neural network can include a plurality of neural networks and/or neural network layers (e.g., recurrent neural networks, LTSM layers, etc.). As an example, each node of the value iteration graph neural network can be other otherwise include a recurrent connection that propagates hidden state information from a previous iteration of the one or more iterations to a current iteration.

In some implementations, the navigation of the autonomous vehicle computing system to the first segment of the transportation network can be based at least in part on the first plurality of node values. More particularly, the plurality of nodes can be masked (e.g., obscured to the value iteration graph neural network, etc.) based on the respectively associated first plurality of node values. Based on the masked nodes, the computing system can generate a subset of nodes from the plurality of nodes. Further, the computing system can determine an optimal node of the subset of nodes based on the first plurality of node values.

As an example, the nodes can be masked based on a threshold value (e.g., a value threshold based on a gain associated with traversing the node, etc.). As another example, the nodes can be masked based on a number of times the segment of the transportation network corresponding to the node has been traversed. As yet another example, the nodes can be masked based on a distance from the node and/or characteristics of the autonomous vehicle (e.g., fuel level of the vehicle, a seating configuration of the vehicle, a current operating mode of the vehicle, a service level associated with the vehicle, etc.).

According to another aspect of the present disclosure, a vehicle (e.g., an autonomous vehicle, a semi-autonomous vehicle, a non-autonomous vehicle, etc.) can generate a route through a transportation network. The transportation network can include a plurality of segments. More particularly, for one or more iterations, a vehicle computing system (e.g., an autonomous vehicle computing system, a non-autonomous vehicle computing system, etc.) can receive sets of agent attention data (e.g., communication vectors, node values, node features, etc.) from additional vehicle computing systems (e.g., remote vehicles, etc.) that are respectively currently located at one or more other segments of the transportation network. The vehicle computing system can input the set of agent attention data into the value iteration graph neural network. Each node (e.g., corresponding to a transportation route segment, etc.) of the value iteration graph neural network can be configured to receive the attention data associated with the corresponding segment.

The vehicle computing system can receive a plurality of node values respectively for the plurality of segments as an output of the value iteration graph neural network (e.g., scalar node values, etc.). Based on the node values, the vehicle computing system can select a next segment to include in the route for the vehicle. For example, the segment associated with the node that has the largest node value can be selected. In such fashion, the vehicle computing system can iteratively select an optimal transportation segment based on agent attention data from remote vehicle(s).

In some implementations, the vehicle computing system can input the set of agent attention data by first determining a set of fused attention data based on the agent attention data and an adjacency matrix that describes distances between the plurality of segments of the transportation network. After determining the set of fused attention data, the fused attention data can be input into the value iteration graph neural network.

In some implementations, the vehicle computing system can communicate updated ego-vehicle attention data to at least one of the one or more additional vehicle computing systems. More particularly, the updated ego-vehicle attention data can be based on the updated set of features for at least a current segment of the transportation network. Each node of the value iteration graph neural network can be configured to update a set of features for the respective segment.

More particularly, each agent (e.g., vehicle computing system, remote vehicle computing system, autonomous vehicle computing system, etc.) can gather local observation and information communicated from other systems, and output the transportation segment it selects to take in the next step. It can be assumed, in some implementations, that each agent can broadcast to the rest of the fleet using common communication technology implementations. In some implementations of the decentralized setting, the policy of each agent can be constrained to be the same (e.g., value iteration graph neural networks trained in an identical or substantially similar fashion, etc.), making the system more robust to failure.

Formally, in some implementations, given a strongly connected directed graph G(V,E) representing the road connectivity, we would like to produce a routing path for a set of L agents [symbol] such that each edge e in E is covered Mₑ times in total across all agents. One example real-world setting can be considered where 1) Mₑ is unknown to all agents until the number has been reached (i.e., only success/failure is revealed upon each action) and 2) only local traffic information can be observed. Let αₜ⁽ⁱ⁾ be the routing action taken by agent i at time t, indicating the next node to traverse. A route can be defined as the sequence of actions [symbol] , where each action can represent an intermediate destination. The policy of a single agent i can be formulated as a function of 1) the map graph G (e.g., the value iteration graph neural network, etc.); 2) local environment observation oₜ⁽ⁱ⁾, the communication messages sent by another agent j,cₜ⁽ⁱ⁾ (e.g., incoming communication vector(s); and 4) the state of the agent sₜ⁽ⁱ⁾. Thus, {αₜ⁽ⁱ⁾}=f(G,oₜ⁽ⁱ⁾,{cₜ₋₁^{(j)}}ⱼ₌₁^{L}:sₜ⁽ⁱ⁾) (1).

In some implementations, it can be assumed that a traffic model F produces the time needed to traverse a route. In such cases, the multi-agent system of the present disclosure can minimize the following objective:

$$\text{?}$$

$$\text{?} \text{indicates text missing or illegible when filed}$$

where M(p,e) is the number of times edge e (e.g., a node of the plurality of nodes, etc.) is visited in a route p.

In some implementations, the value iteration graph neural network can include a communication module. The communication module can save messages sent from other agents in a temporary memory unit, and retrieve the content based on an attention mechanism on the agent level. This information can be sent to a value iteration module for future planning. Secondly, the value iteration graph neural network can be or otherwise include a value iteration module. The value iteration module can run locally on each agent (e.g., vehicle, etc.) and can exchange information among nodes on the map graph (e.g., the value iteration graph neural network, etc.). Third, the value iteration graph neural network can include an attention LSTM planning module. The attention LSTM planning module can iteratively refine the node features for a fixed number of iterations, and can output the value function for each node (e.g., the plurality of node values, etc.). In some implementations, the node with the highest value can be considered the optimal node (e.g., the node to be selected by the vehicle computing system.

The value iteration graph neural network can operate on a strongly connected graph G(V,E) representing segments of a transportation network. Each segment of a transportation network can form a node in the graph, and the goal for each agent can be to pick a node as its next destination. In the value iteration module, the vehicle computing system can attempt to evaluate the “value function” of each node, and can pick the node with the maximum value. Given some initial node features (e.g., a number of times the node has GC been traversed, a distance from the vehicle to the node, an amount of vehicle traffic associated with the node, a number of nodes adjacent to the node, etc.), the value iteration graph neural network can refine the nodes for a fixed number of graph network iterations. The features of the nodes can be decoded into a scalar value function for each node, and the node with the maximum value can be selected as the next destination.

Formally, in some implementations, X={x₁, x₂, . . . , xₙ}can be the set of initial node feature vectors with n the total number of nodes. First, the node input features can be encoded through a linear layer (e.g., a layer of the value iteration graph neural network, etc.) to serve initial features for the value iteration network X₍₀₎=XW_{enc}+b_{enc}. (3). At each planning iteration t, the following iterative update can be performed through a long-short term memory layer (e.g., of the graph network, etc.) with an attention module across neighboring nodes:

$${X}^{( k + 1 )} = {X}^{( k )} + LSTM ( Att ( {X}^{( k )} , A ) ; {H}^{( k )} ) , \qquad ( 4 )$$

for t=1 . . . K and K is the total number of value iteration steps. H(t) can be the hidden state of the LSTM, which contains one state vector per node.

In some implementations, information exchange on the graph level (e.g., a graph attention layer of the value iteration graph neural network, etc.) can happen in the attention module “Att” which can, in some implementations, be a transformer layer (e.g., of the value iteration graph neural network, etc.) that takes in the node features and the adjacency matrix, and outputs the transformed features. Specifically, a first computation can compute the key, query, and value vectors for each node as such:

$${Q}^{( k )} = {X}^{( k )} {W}_{q} + {b}_{q} , \qquad ( 5 )$$

$${K}^{( k )} = {X}^{( k )} {W}_{k} + {b}_{k} , \qquad ( 6 )$$

$${V}^{( k )} = {X}^{( k )} \text{?} , \qquad ( 7 )$$

$$\text{?} \text{indicates text missing or illegible when filed}$$

The attention between each node and every other node can be computed to create an attention matrix Aₐₜₜ ∈R_{n×n}, [symbol] (8). The graph adjacency matrix A can be combined with the attention matrix Aₐₜₜ to represent edge features as follows: [symbol] (9), where g can be a learned neural network (e.g., included within the value iteration graph neural network, etc.).

Alternatively, in some implementations, a dense adjacency matrix can be utilized instead of a graph adjacency matrix g. More particularly, the dense adjacency matrix can be used to encode more edge information in order to speed up the information exchange process for sparse graphs. To utilize the dense adjacency matrix, a first computation(s) can compute GC the pairwise minimum path distance between any pair of nodes D_{i,j}=d(vᵢ,vⱼ). A second computation(s) normalize the distances to form the dense adjacency matrix

$$A = \frac{D - μ}{σ} ,$$

where μ is the element-wise mean of D, and σ is the element-wise standard deviation.

The new node values can be computed using the dense adjacency matrix. More particularly, the new node values can be computed by combining the values produced by all other nodes according to the attention in the fused attention matrix. The output of the graph attention layer can then be fed to an LSTM module (e.g., a component of the value graph iteration neural network, etc.):

$$X \text{?} = LSTM ( \text{?} \text{?} V \text{?} ; H \text{?} ) . \qquad ( 10 )$$

$$\text{?} \text{indicates text missing or illegible when filed}$$

In some implementations, the value iteration graph neural network can continue to iterate the attention LSTM module for K iterations and use a linear layer to project the features into a scalar value function for each node on the graph. The value of all nodes can be masked out if the nodes no longer need to be visited since they have been fully mapped (e.g., the nodes have been traversed a certain number of times). After masking, a softmax can be performed over all remaining nodes to get the action probabilities:

$$π ( {α}_{i} , \text{?} ) = soft max ( {X}^{( K )} {W}_{\text{?}} + {b}_{\text{?}} ) . \qquad ( 11 )$$

$$\text{?} \text{indicates text missing or illegible when filed}$$

In some implementations, the node that has the maximum probability value can be selected to be the next destination. The full route can be formed by connecting the destinations by using a shortest path algorithm on the weighted graph.

Due to the partial observation nature in the realistic problem setup (e.g., traffic and multiple revisits), it can be beneficial to let the agents communicate their local information, encouraging more collaborative behaviors. Towards this goal, the model of the present embodiments can also feature an attention-based communication module. First, when an agent performs an action, the attention-based communication module can use X^{(K)} to output a communication vector for each node: Cₒᵤₜ={c⁽¹⁾, . . . , c^{(L)}}, which can then be broadcasted to all agents. The most recent communication vector from each sender can be temporarily saved on the receiver end. When an agent decides to take a new action, the agent can apply an agent-level attention layer to aggregate information from its receiver inbox.

As an example, agent i, given that Cᵢₙ ∈R^{L×nd} can represent the messages from other agents concatenated together (e.g., aggregated incoming communication vectors, etc.), where L is the number of agents, n is the number of nodes and d is the features dimension. Communication vectors are transformed to produce a query and a value vector:

$${V}_{comm} = {C}_{in} {W}_{q , comm} + {b}_{q , comm} , \qquad ( 12 )$$

$${V}_{comm} = {C}_{in} {W}_{\text{?} , comm} + {b}_{\text{?} , comm} . \qquad ( 13 )$$

$$\text{?} \text{indicates text missing or illegible when filed}$$

Further, the incoming communication vector last outputted by this given agent can also be called upon to produce a key vector:

$${k}_{t , comm} = {C}_{in , t} , {W}_{k , comm} + {b}_{k , comm} . \qquad ( 14 )$$

The key vector can be similarly dotted with the query vectors from all other agents to form a learned linear combination of the communication vectors from all the other agents. These, in some implementations, can be the communication features for input to the value iteration graph neural network. The aggregated communication (e.g., the aggregated second communication vector) can be denoted as Uᵢ:

$${α}_{i} = soft max ( {Q}_{comm} {k}_{i , comm} ) , \qquad ( 15 )$$

$${U}_{i} = {\sum }_{j} {α}_{i , j} {V}_{j} . \qquad ( 16 )$$

Uᵢ can, in some implementations, then be updated as part of X as the node feature inputs to the value iteration module for the next step planning.

The value graph iteration neural network can be trained. More particularly, the value graph iteration neural network can, in some implementations, be trained end-to-end using imitation learning and/or reinforcement learning. For example, in imitation learning, it can be assumed there is an oracle that can solve the training planning problems. It should be noted that this relies on a fully observable environment, and oftentimes the oracle solver can slow down the training process since a training graph can be generated at each iteration. As another example, the network can be trained using reinforcement learning. It should be noted that reinforcement learning can, in some implementations, directly optimize the final objective.

More particularly, in some implementations, imitation learning can be used to train the value graph iteration neural network in an end-to-end fashion. As an example, to generate the ground-truth a* that the imitation learning seeks to imitate, an LKH3 solver can be provided with global information about each problem to solve as a fully observed environment. Based on the ground truth past trajectory, each agent can try to predict the next move a, and the agents can be trained using “teacher-forcing” by minimizing the cross entropy loss for each action, summing across the rollout. The loss of this training can, for example, be averaged across a mini-batch:

$$L = 𝔼 [ - {\sum }_{i , t} log π ( {a}_{t}^{( \text{?} )} ; {s}_{t}^{( \text{?} )} ) ] , \qquad ( 17 )$$

$$\text{?} \text{indicates text missing or illegible when filed}$$

wherein π(a;s) can denotes the probability of taking action a given state s.

Alternatively, or additionally, in some implementations, reinforcement learning can be utilized to train the network (e.g., using episodic reinforcement learning, etc.), and can set the negative total cost of the fully rolled out traversal to be the reward function (e.g., normalized across a mini-batch, etc.). As an example, the reinforcement learning can be utilized as so:

$$\begin{matrix}r = - {\sum }_{i} F ( {p}^{( \text{?} )} ) , & \tilde{r} = ( r - {μ}_{r} ) / {σ}_{r} ,\end{matrix} \qquad ( 18 )$$

$$\begin{matrix}L = {𝔼}_{\text{?}} \tilde{r} , & ∇ L = {𝔼}_{r} [ r {\sum }_{t , t} ∇ log π ( {a}_{t}^{( \text{?} )} ; {s}_{t}^{( \text{?} )} ) ]\end{matrix} . \qquad ( 19 )$$

$$\text{?} \text{indicates text missing or illegible when filed}$$

Embodiments in accordance with the disclosed technology provide a number of technical effects and benefits, particularly in the areas of computing technology, autonomous and/or non-autonomous vehicles, and the integration of computing technology with vehicles. In particular, example implementations of the disclosed technology provided improved techniques for generating routes for multiple agents (e.g., autonomous vehicles, etc.) in a transportation network. For example, by utilizing one or more implementations of the disclosed technology, a number of autonomous vehicle computing systems iteratively share real-time transportation conditions (e.g., node features) with each other to more optimally plan routes. Further, one or more implementations of the disclosed technology can, in a distributed and decentralized fashion, optimize the distribution of agents across the transportation network so that the transportation network can be more efficiently saturated. As an example, autonomous vehicles of a ride share service can communicate with each other to optimally saturate the most used transportation segments of a transportation network. By more accurately and efficiently communicating node features, embodiments in accordance with the present disclosure can enable the fastest and most efficient route planning based on real-time conditions, providing improved vehicle efficiency/reduced energy consumption and reducing the number of communication resources consumed.

It should be noted that although the subject matter of the present disclosure is discussed primarily with regards to autonomous vehicles, the systems and methods of the present embodiments can also be utilized with conventional vehicles (e.g., human-operated vehicles). As such, the systems and methods of the present disclosure can also be utilized to generate routes for non-autonomous vehicles through segment(s) of a transportation network.

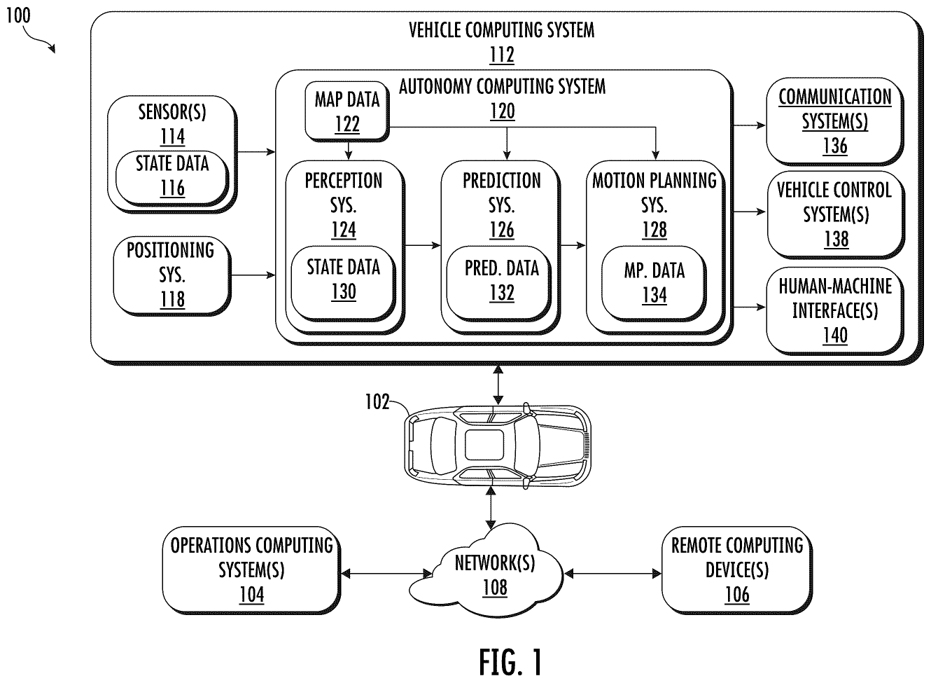

With reference now to the FIGS., example aspects of the present disclosure will be discussed in further detail. FIG. 1 depicts an example system 100 overview according to example implementations of the present disclosure. More particularly, FIG. 1 illustrates a vehicle 102 (e.g., an autonomous vehicle, etc.) including various systems and devices configured to control the operation of the vehicle. For example, the vehicle 102 can include an onboard vehicle computing system 112 (e.g., located on or within the vehicle) that is configured to operate the vehicle 102. Generally, the vehicle computing system 112 can obtain sensor data 116 from a sensor system 114 onboard the vehicle 102, attempt to comprehend the vehicle's surrounding environment by performing various processing techniques on the sensor data 116, and generate an appropriate motion plan 134 through the vehicle's surrounding environment.

As illustrated, FIG. 1 shows a system 100 that includes the vehicle 102; a communications network 108; an operations computing system 104; one or more remote computing devices 106; the vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can be configured to monitor and communicate with the vehicle 102 and/or its users to coordinate a vehicle service provided by the vehicle 102. To do so, the operations computing system 104 can communicate with the one or more remote computing devices 106 and/or the vehicle 102 via one or more communications networks including the communications network 108. The communications network 108 can send and/or receive signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. the Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including sending and/or receiving data or signals to and from the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices. The remote computing device(s) 106 can be remote from the vehicle computing system 112. The remote computing device(s) 106 can include, for example, one or more operator/developer devices associated with one or more vehicle operators (e.g., a laptop located onboard for the vehicle operator), user devices associated with one or more vehicle passengers (e.g., an onboard rider tablet), etc. As used herein, device can refer to any physical device and/or a virtual device such as, for example, compute nodes, a computing blades, hosts, virtual machines, etc. One or more of the devices can receive input and/or instructions from a user or exchange signals or data with an item or other computing device or computing system (e.g., the operations computing system 104).

In some implementations, the one or more remote computing devices 106 can be used to determine and/or modify one or more states of the vehicle 102 including a location (e.g., a latitude and longitude), a velocity, an acceleration, a trajectory, a heading, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, a motorcycle, a train, a tram, a bus, a truck, a tracked vehicle, a light electric vehicle, a moped, a scooter, and/or an electric bicycle), an aircraft (e.g., airplane or helicopter), a boat, a submersible vehicle (e.g., a submarine), an amphibious vehicle, a hovercraft, a robotic device (e.g. a bipedal, wheeled, or quadrupedal robotic device), and/or any other type of vehicle. The vehicle 102 can be an autonomous vehicle that can perform various actions including driving, navigating, and/or operating, with minimal and/or no interaction from a human driver. The vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

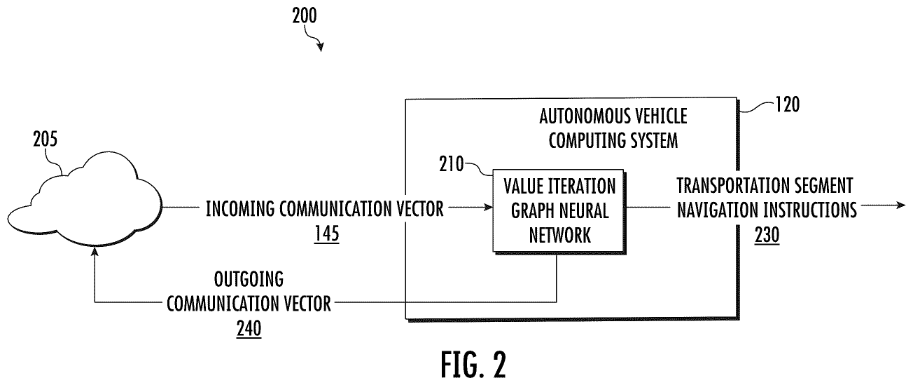

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. As discussed in further detail with reference to FIG. 2, the one or more computing devices of the vehicle computing system 112 can include various components for performing various operations and functions. For instance, the one or more computing devices of the vehicle computing system 112 can include one or more processors and one or more tangible non-transitory, computer readable media (e.g., memory devices). The one or more tangible non-transitory, computer readable media can store instructions that when executed by the one or more processors cause the vehicle 102 (e.g., its computing system, one or more processors, and other devices in the vehicle 102) to perform operations and/or functions, including those described herein for authenticating messages between processes associated with the vehicle computing system 112. Furthermore, the vehicle computing system 112 can perform one or more operations associated with the control, exchange of data, and/or operation of various devices and systems including robotic devices and/or other computing devices.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 102 (e.g., within range or a field of view of one or more of the one or more sensors 114). The one or more sensors 114 can include one or more Light Detection and Ranging (LiDAR) systems, one or more Radio Detection and Ranging (RADAR) systems, one or more cameras (e.g., visible spectrum cameras and/or infrared cameras), one or more sonar systems, one or more motion sensors, and/or other types of image capture devices and/or sensors. The sensor data 116 can include image data, radar data, LiDAR data, sonar data, and/or other data acquired by the one or more sensors 114. The one or more objects can include, for example, pedestrians, vehicles, bicycles, buildings, roads, foliage, utility structures, bodies of water, and/or other objects. The one or more objects can be located on or around (e.g., in the area surrounding the vehicle 102) various parts of the vehicle 102 including a front side, rear side, left side, right side, top, or bottom of the vehicle 102. The sensor data 116 can be indicative of locations associated with the one or more objects within the surrounding environment of the vehicle 102 at one or more times. For example, sensor data 116 can be indicative of one or more LiDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and/or location of different roadways, road segments, buildings, or other items or objects (e.g., lampposts, crosswalks and/or curbs); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine a position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing devices 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the sensor data 116 (e.g., LiDAR data, camera data) to match it to a map of the surrounding environment to get a determination of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment, including for example, a motion plan that navigates the vehicle 102 around the current and/or predicted locations of one or more objects detected by the one or more sensors 114. The autonomy computing system 120 can control the one or more vehicle control systems 138 to operate the vehicle 102 according to the motion plan.

The autonomy computing system 120 can identify one or more objects that are proximate to the vehicle 102 based at least in part on the sensor data 116 and/or the map data 122. For example, the perception system 124 can obtain state data 130 descriptive of a current and/or past state of an object that is proximate to the vehicle 102. The state data 130 for each object can describe, for example, an estimate of the object's current and/or past: location and/or position; speed; velocity; acceleration; heading; orientation; size/footprint (e.g., as represented by a bounding shape); class (e.g., pedestrian class vs. vehicle class vs. bicycle class), and/or other state information. The perception system 124 can provide the state data 130 to the prediction system 126 (e.g., for predicting the movement of an object).

The prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128. In some implementations, the perception and prediction systems 124, 126 (and/or other systems) can be combined into one system and share computing resources.

In some implementations, the prediction system 126 can utilize one or more machine-learned models. For example, the prediction system 126 can determine prediction data 132 including a predicted trajectory (e.g., a predicted path, one or more predicted future locations, etc.) along which a respective object is predicted to travel over time based on one or more machine-learned models. By way of example, the prediction system 126 can generate such predictions by including, employing, and/or otherwise leveraging a machine-learned prediction generator model. For example, the prediction system 126 can receive state data 130 (e.g., from the perception system 124) associated with one or more objects within the surrounding environment of the vehicle 102. The prediction system 126 can input the state data 130 (e.g., BEV image, LIDAR data, etc.) into the machine-learned prediction generator model to determine trajectories of the one or more objects based on the state data 130 associated with each object. For example, the machine-learned prediction generator model can be previously trained to output a future trajectory (e.g., a future path, one or more future geographic locations, etc.) of an object within a surrounding environment of the vehicle 102. In this manner, the prediction system 126 can determine the future trajectory of the object within the surrounding environment of the vehicle 102 based, at least in part, on the machine-learned prediction generator model.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections). In some implementations, the communications system 136 can allow communication among one or more of the system on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat). For example, the autonomy computing system 120 can provide one or more outputs including a graphical display of the location of the vehicle 102 on a map of a geographical area within one kilometer of the vehicle 102 including the locations of objects around the vehicle 102. A passenger of the vehicle 102 can interact with the one or more human-machine interfaces 140 by touching a touchscreen display device associated with the one or more human-machine interfaces to indicate, for example, a stopping location for the vehicle 102.

In some embodiments, the vehicle computing system 112 can perform one or more operations including activating, based at least in part on one or more signals or data (e.g., the sensor data 116, the map data 122, the state data 130, the prediction data 132, and/or the motion plan data 134) one or more vehicle systems associated with operation of the vehicle 102. For example, the vehicle computing system 112 can send one or more control signals to activate one or more vehicle systems that can be used to control and/or direct the travel path of the vehicle 102 through an environment.

By way of further example, the vehicle computing system 112 can activate one or more vehicle systems including: the communications system 136 that can send and/or receive signals and/or data with other vehicle systems, other vehicles, or remote computing devices (e.g., remote server devices); one or more lighting systems (e.g., one or more headlights, hazard lights, and/or vehicle compartment lights); one or more vehicle safety systems (e.g., one or more seatbelt and/or airbag systems); one or more notification systems that can generate one or more notifications for passengers of the vehicle 102 (e.g., auditory and/or visual messages about the state or predicted state of objects external to the vehicle 102); braking systems; propulsion systems that can be used to change the acceleration and/or velocity of the vehicle which can include one or more vehicle motor or engine systems (e.g., an engine and/or motor used by the vehicle 102 for locomotion); and/or steering systems that can change the path, course, and/or direction of travel of the vehicle 102.

The following describes the technology of this disclosure within the context of an autonomous vehicle for example purposes only. As described herein, the technology of the present disclosure is not limited to an autonomous vehicle and can be implemented within other robotic and/or other computing systems, such as those managing messages from a plurality of disparate processes.

As an example, the system 100 of the present disclosure can include any combination of the vehicle computing system 112, one or more subsystems and/or components of the vehicle computing system 112, one or more remote computing systems such as the operations computing system 104, one or more components of the operations computing system 104, and/or other remote computing devices 106. For example, each vehicle sub-system can include one or more vehicle device(s) and each remote computing system/device can include one or more remote devices. The plurality of devices of the system 100 can include one or more of the one or more vehicle device(s) (e.g., internal devices) and/or one or more of the remote device(s).

Although many examples are described herein with respect to autonomous vehicles, the disclosed technology is not limited to autonomous vehicles. For instance, any vehicle may utilize the technology described herein for determining object intention. For example, a non-autonomous vehicle may utilize aspects of the present disclosure to determine the intention of one or more objects (e.g., vehicles, bicycles, etc.) proximate to a non-autonomous vehicle. Such information may be utilized by a non-autonomous vehicle, for example, to provide informational notifications to an operator of the non-autonomous vehicle. For instance, the non-autonomous vehicle can notify or otherwise warn the operator of the non-autonomous vehicle based on a determined object intention. Additionally, or alternatively, the disclosed technology can be implemented and utilized by other computing systems such as other robotic computing systems.

FIG. 2 depicts an example flow diagram 200 depicting a process for selecting an optimal transportation segment node based on incoming communication vectors according to example embodiments of the present disclosure. To facilitate the selection of an optimal transportation segment node (e.g., a street segment in a city, etc.) the autonomous vehicle computing system 120 can obtain an incoming communication vector 145 via network 205. The incoming communication vector 145 can describe local environmental observations of another agent in the multi-agent graph network. As an example, a first agent (e.g., an autonomous vehicle, etc.) may observe local environmental conditions (e.g., road construction, traffic, weather conditions, accidents, etc.) and include data describing the local environmental conditions in a communication vector that can be sent via network 205 to the autonomous vehicle computing system 120 (e.g., incoming communication vector 145). Additionally, or alternatively, the incoming communication vector can include node values (e.g., attentional weights, etc.) that are associated with one or more other segments of the transportation network. As an example, a first agent can calculate node values (e.g., based on attentional weights, observed node features, etc.) for one or more nodes in the network. The first agent can include data describing the node values in the incoming communication vector 145. In such fashion, the incoming communication vector 145 can include data that is more locally accurate than the data available to the autonomous vehicle computing system, therefore optimizing the selection of transportation segment nodes.

The incoming communication vector 145 can be input into the value iteration graph neural network 210 (e.g., by the autonomous vehicle computing system 120, etc.). The value iteration graph neural network can utilize the incoming communication vector 145, alongside one or more node values associated with nodes of the graph neural network 210, to generate transportation segment navigation instructions 230. The transportation segment navigation instructions 230 can identify a target transportation segment to navigate the agent (e.g., autonomous vehicle, etc.) to. Although the incoming communication vector 145 is depicted as a singular communication vector, it should be noted that in some implementations, the autonomous vehicle computing system 120 can receive a plurality of incoming communication vectors 140 from a respective plurality of agents via network 205.

It should be noted that the navigation instructions 230 can, in some implementations, include a number of intermediate destinations. More formally, A route (e.g., the route indicated by the transportation segment navigation instructions 230) can be defined as the sequence of actions p⁽ⁱ⁾=[a₀⁽ⁱ⁾, . . . , o_{M}⁽ⁱ⁾], where each action can represent an intermediate destination. The policy of a single agent i (e.g., the autonomous vehicle computing system 120) can be formulated as a function of 1) the map graph G (e.g., the value iteration graph neural network 210, etc.); 2) local environment observation oₜ⁽ⁱ⁾ the incoming communication vector 145 sent by another agent j, cₜ^{(j)}; and 4) the state of the agent sₜ⁽ⁱ⁾. Thus, [symbol] (1).

The value graph iteration neural network 210 can, in some implementations, generate an outgoing communication vector 240 alongside the transportation segment navigation instructions 230 (e.g., concurrently, subsequently, etc.). The outgoing communication vector 240 can be or otherwise include the data included in the incoming communication vector 145. As an example, the outgoing communication vector may include local observations of the autonomous vehicle (e.g., local sensor data collected by the autonomous vehicle computing system 120, etc.). As another example, the outgoing communication vector 240 can include one or more node values of the value iteration graph neural network 210. In some implementations, the outgoing communication vector 240 can be transmitted to one or more other agents (e.g., autonomous vehicles, etc.) via network 205. For example, the outgoing communication vector 240 can be transmitted via network 205 to the agent that transmitted the incoming communication vector 145.

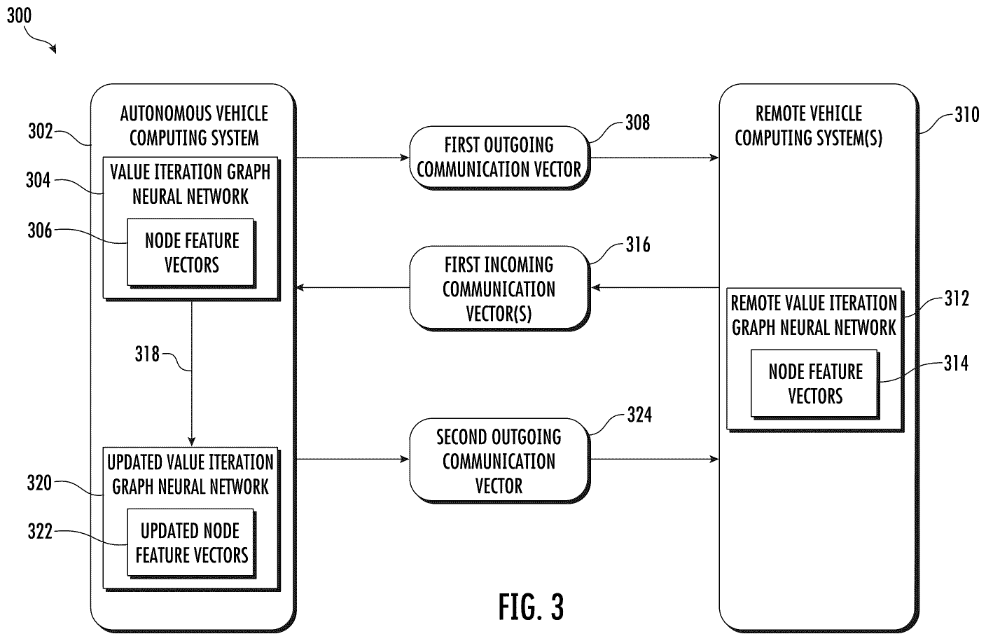

FIG. 3 depicts a flowchart illustrating an example method 300 for facilitating incoming and outgoing communication vectors across a plurality of autonomous vehicle computing systems according to example embodiments of the present disclosure. More particularly, the autonomous vehicle computing system 302 can include a value iteration graph neural network 304. The value iteration graph neural network 304 can include a plurality of nodes that respectively correspond to a plurality of segments of a transportation network (e.g., street segments in a city transportation network, subway lines in a city transportation network, etc.). A plurality of node feature vectors 306 can be respectively associated with the plurality of nodes of the value iteration graph neural network 304. More particularly, the node feature vectors for each node segments can store values associated with one or more features of the node. Node features can, for example, include a number of times the node has been traversed. As another example, the features can include a distance from the autonomous vehicle to the node. As yet another example, the features can include an amount of vehicle traffic associated with the node or a number of nodes adjacent to the node. Other arbitrary features descriptive of conditions at or characteristics of the segments can be used

The autonomous vehicle computing system 302 can use the value iteration graph neural network 304 to update the node feature vectors 306 and determine a first plurality of node values for the plurality of nodes. Based on the node feature vectors 306 and/or associated node values determined from the node feature vectors 306, the autonomous vehicle computing system 302 can select a first segment of the transportation network to which to navigate. Concurrently, or subsequently, the autonomous vehicle computing system 302 can generate and transmit a first outgoing communication vector 308 to remote vehicle computing system(s) 310. The outgoing communication vector 308, as described in detail with regards to FIG. 2, can include local observational data, feature vector(s) 306, and/or node value(s) of the value graph iteration neural network 304.

Remote vehicle computing system(s) 310 can receive the first outgoing communication vector 308. Remote vehicle computing system(s) 310 can include one or more other autonomous vehicle computing systems traversing the transportation network of the value iteration graph neural network 304. More particularly, each of the remote vehicle computing system(s) 310 can include a remote value iteration graph neural network 312. In some implementations, the remote value iteration graph neural network 312 can be an instance of the value graph iteration neural network 304. More particularly, the value graph iteration neural network 304 and the remote value iteration graph neural network 312 may both be instances of a previously trained value iteration graph neural network. As an example, a first graph neural network can be trained and instantiated with initial, default feature vector(s) for each node of the graph corresponding to the transportation network. As such, the node feature vectors 306 and 304 can, in some implementations, initially share the same feature vectors for each node. However, as each autonomous vehicle computing system (e.g., 302 and 310) traverse the transportation network, the parameters of the feature vectors (e.g., 306 and 314) can diverge. In such fashion, the autonomous vehicle computing system 302 and the remote vehicle computing system(s) 310 can communicate (e.g., via communication vector(s), etc.) locally observed details and associated node values to more optimally select nodes in the transportation network

The remote vehicle computing system(s) 310 can input the first outgoing communication vector into the remote value iteration graph neural network 312. Based on the first outgoing communication vector 308 and the node feature vectors 314, the remote vehicle computing system(s) 310 can select a first segment of the transportation network to which to navigate. Concurrently, or subsequently, the autonomous vehicle computing system 302 can generate and transmit a first incoming communication vector 316 to the autonomous vehicle computing system 302. It should be noted that although the remote value iteration graph neural network 312 is depicted as a single neural network, the remote value iteration graph neural network 312 can be a plurality of neural networks associated with a plurality of remote vehicle computing system(s) 310, which can subsequently travel to a plurality of associated first segments.

The autonomous vehicle computing system can receive the first incoming communication vector(s) 316 and input the vector(s) into the value iteration graph neural network 304. In some implementations, the autonomous vehicle computing system 302 can use a machine-learned attention aggregation layer (e.g., a layer of the graph neural network 304) to process the first incoming communication vector 316. More particularly, a machine-learned attention aggregation layer of the value iteration graph neural network 304 can be used to generate an aggregated incoming communication vector 316 based on attentional actor weights associated with each of the one or more remote autonomous vehicle computing systems 310. The one or more communication vectors can be aggregated such that the aggregated communication vector 316 provides scalar node values for each node of the value iteration graph neural network 304. In such fashion, the aggregated incoming communication vector can easily facilitate updating of the nodes of the value iteration graph neural network 304.

Based on the first incoming communication vector(s) 316 and local observational data, the autonomous vehicle computing system can, at step 318, update the value iteration graph neural network 304 to updated value iteration graph neural network 320. The updated value iteration graph neural network 320 can include updated node feature vectors 322. The updated node feature vectors 322 can include any information included in the first incoming communication vector(s) 316. As an example, the first incoming communication vector(s) 316 may indicate that a node of the transportation network (e.g., a street segment, etc.) has a large amount of traffic. The updated feature node vectors 322 can be updated to reflect the perceived traffic associated with the respective node.

The autonomous vehicle computing system 302 can use the updated value iteration graph neural network 320 determine a first plurality of node values for the plurality of nodes. Based on the updated node feature vectors 322 and/or associated node values determined from the node feature vectors 322, the autonomous vehicle computing system 302 can select a second segment of the transportation network to which to navigate. Concurrently, or subsequently, the autonomous vehicle computing system 302 can generate and transmit a second outgoing communication vector 324 to remote vehicle computing system(s) 310. The outgoing communication vector 324, as described in detail with regards to FIG. 2, can include local observational data, updated feature vector(s) 322, and/or node value(s) of the value graph iteration neural network 320. In such fashion, the remote vehicle computing system(s) 310 and the autonomous vehicle computing system 302 can quickly and efficiently update the real-time status of the node feature vectors (e.g., 306, 314, 322, etc.) of the transportation network.

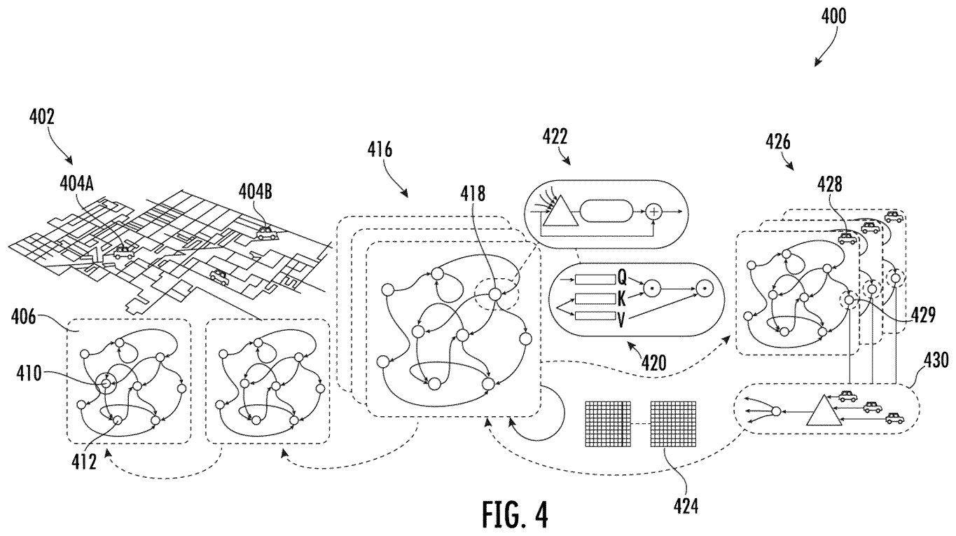

FIG. 4 depicts a block diagram depicting an example architecture and implementation for a value iteration graph neural network 400 according to example embodiments of the present disclosure. More particularly, the value iteration graph neural network 400 can include a map graph 402. The map graph 402 can include one or more nodes that correspond to transportation segments of a transportation segment network (e.g., nodes 410 and 412, etc.) For example, node 410 and node 412 can represent transportation segments in a transportation network (e.g., street segments in a city-level transportation network, etc.). The map graph can be traversed by a number of agents (e.g., autonomous vehicles, etc.). For example, the autonomous vehicle agents 404A and 404B can traverse the transportation network represented by the map graph.

Each of the autonomous vehicles 404A and 404B can include a distributed, discrete map graph as part of a distributed value iteration graph neural network 400. More particularly, each autonomous vehicle 404A and 404B can include their own map graph 402, value iteration module 416, communication module 426, and/or any other components of a value iteration graph neural network. In such fashion, each autonomous vehicle (e.g., 404A and 404B) can independently utilize their own respective value iteration graph neural networks 400.

The value iteration graph neural network 400 can include a value iteration module 416. The value iteration module 416 can run locally on each agent (e.g., autonomous vehicles 404A and 404B, etc.) and can exchange information among nodes on the map graph 402 (e.g., 410, 412, etc.) via the communication module 426. More particularly, the autonomous vehicle can utilize the value iteration module 416 to evaluate the “value function” of each node (e.g., 410, 412, etc.), and can pick the node with the maximum value. Given some initial node features (e.g., a number of times the node has been traversed, a distance from the autonomous vehicle to the node, an amount of vehicle traffic associated with the node, a number of nodes adjacent to the node, etc.), the value iteration graph neural network 400 can refine the nodes for a fixed number of graph network iterations. The features of the nodes can be decoded into a scalar value function for each node, and the node with the maximum value can be selected as the next destination.

The value iteration graph neural network 400 can include a communication module 426. The communication module can facilitate communication between agents (e.g., autonomous vehicles 404A and 404B) through the use of communication vector(s) to more efficiently optimize the values of the nodes for each agent based on real-time information. More particularly, the communication module can facilitate communication from a first agent (e.g., autonomous vehicle 428) to a second agent for a node 429. The second agent can receive the incoming communication vector(s) from other agents and can apply agent-level attention 430 (e.g., attentional weights, values, etc.) to the information encoded in the communication vector. Based on the agent-level attention 430, the second agent can update the value iteration module with data described by the incoming communication vector. In such fashion, the second agent can update its value iteration module 416 with information observed by the first agent 428 and encoded in the communication vector.

Formally, in some implementations, X={x₁, x₂, . . . , xₙ}can be a set of initial node feature vectors with n the total number of nodes (e.g., 410, 412, etc.). First, the node input features can be encoded through a linear layer (e.g., a layer of the value iteration graph neural network, etc.) to serve initial features for the value iteration network 400 X₍₀₎=XW_{enc}+b_{enc}. (3). At each planning iteration t, the following iterative update can be performed through a long-short term memory layer 422 with an attention module (e.g., the attention encoder 420) across neighboring nodes:

$${X}^{( k + 1 )} = {X}^{( k )} + LSTM ( Att ( {X}^{( k )} , A ) ; {H}^{( k )} ) , \qquad ( 4 )$$

for t=1 . . . K and K is the total number of value iteration steps. H(t) can be the hidden state of the LSTM 422, which contains one state vector per node (e.g., 410, 412, etc.).

In some implementations, information exchange on the level of the map graph 402 can be facilitated by the attention encoder 420 which can, in some implementations, be a transformer layer (e.g., of the value iteration graph neural network 400, etc.) that takes in the node features and the adjacency matrix 424, and outputs the transformed features 418. Specifically, a first computation can compute the key, query, and value vectors for each node (e.g., 418, etc.) as such:

$${Q}^{( k )} = {X}^{( k )} {W}_{q} + {b}_{q} , \qquad ( 5 )$$

$${K}^{( k )} = {X}^{( k )} {W}_{k} + {b}_{k} , \qquad ( 6 )$$

$${V}^{( k )} = {X}^{( k )} {W}_{v} + {b}_{v} , \qquad ( 7 )$$

The attention between each node and every other node can be computed to create an attention matrix Aₐₜₜ ∈R^{n×n}, [symbol] (8). The graph adjacency matrix A (e.g., 424) can be combined with the attention matrix Aₐₜₜ to represent edge features as follows: [symbol] (9), where g can be a learned neural network (e.g., included within the value iteration graph neural network, etc.).

Alternatively, in some implementations, a dense adjacency matrix 424 can be utilized instead of a graph adjacency matrix g. More particularly, the dense adjacency matrix 424 can be used to encode more edge information in order to speed up the information exchange process for sparse graphs (e.g., map graph 402, etc.). To utilize the dense adjacency matrix 424, a first computation(s) can compute the pairwise minimum path distance between any pair of nodes D_{i,j}=d(vᵢ,vⱼ). A second computation(s) normalize the distances to form the dense adjacency matrix 424

$$A = \frac{D - μ}{σ} ,$$

where μ is the element-wise mean of D, and σ is the element-wise standard deviation.

The new node values can be computed using the dense adjacency matrix 424. More particularly, the new node values can be computed by combining the values produced by all other nodes (e.g., 410, 412, etc.) according to the attention in the fused attention matrix. The output of the graph attention layer can then be fed to an LSTM module 422:

$$\text{?} = LSTM ( \text{?} ) \text{?}$$

$$\text{?} \text{indicates text missing or illegible when filed}$$

In some implementations, the value iteration graph neural network can continue to iterate the attention LSTM 422 module for K iterations and use a linear layer to project the features into a scalar value function for each node on the graph. The value of all nodes can be masked out if the nodes no longer need to be visited since they have been fully mapped (e.g., GC the nodes have been traversed a certain number of times). After masking, a softmax can be performed over all remaining nodes to get the action probabilities:

$$\text{?} = softmax ( {X}^{( K )} \text{?} + \text{?} ) \text{?} \qquad ( 11 )$$

$$\text{?} \text{indicates text missing or illegible when filed}$$

In some implementations, the node that has the maximum probability value can be selected to be the next destination. The full route can be formed by connecting the destinations by using a shortest path algorithm on the weighted graph.

The model of the present embodiments can also feature an attention-based communication module 426. First, when an agent (e.g., 428) performs an action, the attention-based communication module 426 can use X^{(K)} to output a communication vector for each node: Cₒᵤₜ={c⁽¹⁾, . . . , c^{(L)}}, which can then be broadcasted to all agents (e.g., 404A, 404B, etc.). The most recent communication vector from each sender can be temporarily saved on the receiver end. When agent 428 decides to take a new action, the agent 428 can apply an agent-level attention layer 430 to aggregate information from its receiver inbox.

As an example, agent 428, given that Cᵢₙ ∈R^{L×nd} can represent the messages from other agents concatenated together (e.g., aggregated incoming communication vectors, etc.), where L is the number of agents, n is the number of nodes and d is the features dimension. Communication vectors are transformed to produce a query and a value vector:

$$\text{?} = \text{?} + \text{?} \qquad ( 12 )$$

$$\text{?} = \text{?} + \text{?} \qquad ( 13 )$$

$$\text{?} \text{indicates text missing or illegible when filed}$$

Further, the incoming communication vector last outputted by this given agent 428 can also be called upon to produce a key vector:

$${k}_{t , comm} = {C}_{in , t} , {W}_{k , comm} + {b}_{k , comm} . \qquad ( 14 )$$

The key vector can be similarly dotted with the query vectors from all other agents to form a learned linear combination of the communication vectors from all the other agents. These, in some implementations, can be the communication features for input to the value iteration graph neural network 400. The aggregated communication (e.g., the aggregated second communication vector) can be denoted as Uᵢ:

$$\text{?} = softmax ( \text{?} ) \text{?} \qquad ( 15 )$$

$${U}_{i} = \text{?} \qquad ( 16 )$$

$$\text{?} \text{indicates text missing or illegible when filed}$$

Uᵢ can, in some implementations, then be updated as part of X as the node feature inputs to the value iteration module for the next step planning.

In some implementations, nodes can be masked 406 (e.g., obscured to the value iteration graph neural network 400, etc.) based on the respectively associated first plurality of GC node values. Based on the masked nodes 406, the value iteration graph neural network 400 can generate a subset of nodes from the plurality of nodes. As an example, mask 406 can be applied to the nodes to mask node 412, leaving only node 410 as a potential destination. Further, the computing system can determine an optimal node of the subset of nodes based on the first plurality of node values.

For example, the nodes (e.g., 410 and 412) can be masked based on a threshold value (e.g., a value threshold based on a gain associated with traversing the node, etc.). As another example, the nodes (e.g., 410 and 412) can be masked based on a number of times the segment of the transportation network corresponding to the node has been traversed. As yet another example, the nodes can be masked based on a distance from the node and/or characteristics of the autonomous vehicle (e.g., fuel level of the vehicle, a seating configuration of the vehicle, a current operating mode of the vehicle, a service level associated with the vehicle, etc.).

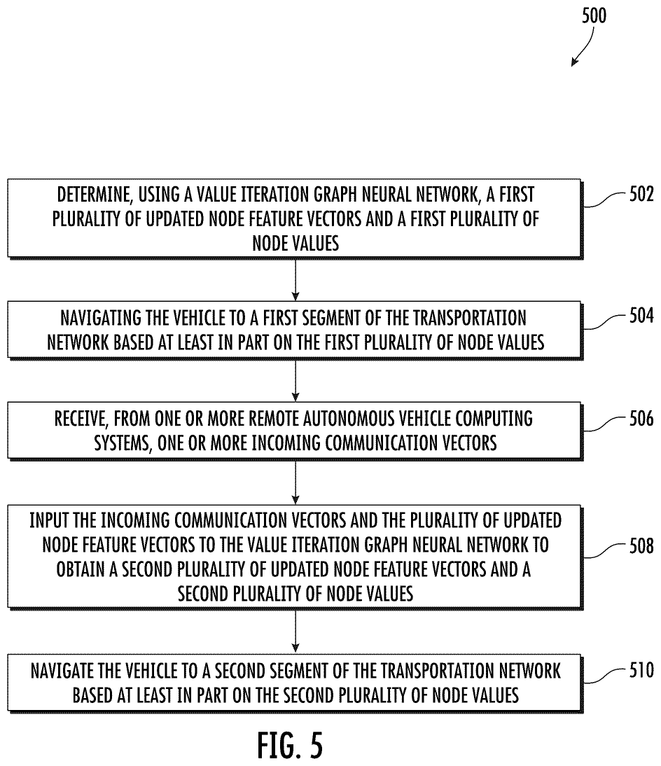

FIG. 5 depicts a flowchart for selecting and navigating to optimal transportation segment nodes based on incoming communication vectors according to example embodiments of the present disclosure. One or more portion(s) of the method 500 can be implemented by a computing system that includes one or more computing devices such as, for example, the computing systems described with reference to the other figures (e.g., the vehicle computing system 112, the autonomy computing system 120, etc.). Each respective portion of the method actors can be performed by any (or any combination) of one or more computing devices. Moreover, one or more portion(s) of the method actors can be implemented as an algorithm on the hardware components of the device(s) described herein (e.g., as in FIGS. 1-4), and/or on a training computing system accessible by a network. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for example illustrated purposes and is not meant to be limiting. One or more portions of method actors can be performed additionally, or alternatively, by other systems.

At 502, the method 500 can include determining, using a value iteration graph neural network, a first plurality of updated node feature vectors and a first plurality of node values. More particularly, the value iteration graph neural network can include a plurality of nodes that respectively correspond to a plurality of segments of a transportation network. A plurality of node feature vectors can be respectively associated with the plurality of nodes. An autonomous vehicle computing system can use the value iteration graph neural network to update the node feature vectors to determine a first plurality of updated node feature vectors and to determine a first plurality of node values for the plurality of nodes. Based on the first plurality of node values, the autonomous vehicle can select a first segment of the transportation network to which to navigate.

In some implementations, using the value iteration graph neural network to determine the first plurality of updated node feature vectors and the first plurality of node values can include using a machine-learned attention layer of the value iteration graph neural network. The machine-learned attention layer can generate a plurality of attentional weights respectively associated with the plurality of nodes (e.g., based on a distance from the vehicle, spatial relationships between the segments, etc.). As one example, the autonomous vehicle computing system can determine a dense adjacency matrix that describes a distance between each of the plurality of nodes, and can generate an attention matrix based on the dense adjacency matrix and the plurality of attentional weights. Based on the attention matrix, the autonomous vehicle computing system can update the plurality of node feature vectors (e.g., across one or more iterations) to obtain the first plurality of updated node feature vectors and the first plurality of node values (e.g., respectively for the plurality of nodes, etc.).

In some implementations, the node feature vectors can describe one or more features of the node. As an example, the features can include a number of times the node has been traversed. As another example, the features can include a distance from the autonomous vehicle to the node. As yet another example, the features can include an amount of vehicle traffic associated with the node or a number of nodes adjacent to the node. Other arbitrary features descriptive of conditions at or characteristics of the segments can be used.

In some implementations, the value iteration graph neural network can include a plurality of neural networks and/or neural network layers (e.g., recurrent neural networks, LTSM layers, etc.). As an example, each node of the value iteration graph neural network can be other otherwise include a recurrent connection that propagates hidden state information from a previous iteration of the one or more iterations to a current iteration.

Formally, in some implementations, given a strongly connected directed graph G(V,E) representing the road connectivity (e.g., the map graph 402 of FIG. 4), we would like to produce a routing path for a set of L agents {p⁽ⁱ⁾}ᵢ₌₁^{L} such that each edge e in E is covered Mₑ times in total across all agents. One example real-world setting can be considered where 1) Mₑ is unknown to all agents until the number has been reached (i.e., only success/failure is revealed upon each action) and 2) only local traffic information can be observed. Let αₜ⁽ⁱ⁾ be the routing action taken by agent i at time t, indicating the next node to traverse. A route can be defined as the sequence of actions p⁽ⁱ⁾=[a₀⁽ⁱ⁾, . . . , a_{M}⁽ⁱ⁾], where each action can represent an intermediate destination. The policy of a single agent i can be formulated as a function of 1) the map graph G (e.g., the value iteration graph neural network, etc.); 2) local environment observation oₜ⁽ⁱ⁾, the communication messages sent by another agent j, cₜ⁽ⁱ⁾ (e.g., incoming communication vector(s); and 4) the state of the agent sₜ⁽ⁱ⁾. Thus,

$$\{ \text{?} \} = f ( G , {o}_{t}^{( i )} , {\{ {c}_{t - 1}^{( j )} \}}_{j = 1}^{L} ; \text{?} ) . \qquad ( 1 )$$

$$\text{?} \text{indicates text missing or illegible when filed}$$

In some implementations, it can be assumed that a traffic model F produces the time needed to traverse a route. In such cases, the multi-agent system of the present disclosure can minimize the following objective:

$$\text{?} \text{?} \qquad ( 2 )$$

$$subject to \text{?} \geq \text{?}$$

$$\text{?} \text{indicates text missing or illegible when filed}$$

where M(p,e) is the number of times edge e (e.g., a node of the plurality of nodes, etc.) is visited in a route p.

In some implementations, the value iteration graph neural network can include a communication module. The communication module can save messages sent from other agents in a temporary memory unit, and retrieve the content based on an attention mechanism on the agent level. This information can be sent to a value iteration module for future planning. Secondly, the value iteration graph neural network can be or otherwise include a value iteration module. The value iteration module can run locally on each agent (e.g., autonomous vehicle, etc.) and can exchange information among nodes on the map graph (e.g., the value iteration graph neural network, etc.). Third, the value iteration graph neural network can include an attention LSTM planning module. The attention LSTM planning module can iteratively refine the node features for a fixed number of iterations, and can output the value function for each node (e.g., the plurality of node values, etc.). In some implementations, the node with the highest value can be considered the optimal node (e.g., the node to be selected by the autonomous vehicle computing system.

In some implementations, each of the one or more nodes of the value iteration graph neural network can include a recurrent connection that propagates hidden state information from a previous iteration of the one or more interactions.

The value iteration graph neural network can operate on a strongly connected graph G(V,E) representing segments of a transportation network. Each segment of a transportation network can form a node in the graph, and the goal for each agent can be to pick a node as its next destination. In the value iteration module, the autonomous vehicle computing system can attempt to evaluate the “value function” of each node, and can pick the node with the maximum value. Given some initial node features (e.g., a number of times the node has been traversed, a distance from the autonomous vehicle to the node, an amount of vehicle traffic associated with the node, a number of nodes adjacent to the node, etc.), the value iteration graph neural network can refine the nodes for a fixed number of graph network iterations. The features of the nodes can be decoded into a scalar value function for each node, and the node with the maximum value can be selected as the next destination.

Formally, in some implementations, X={x₁, x₂, . . . , xₙ}can be the set of initial node feature vectors with n the total number of nodes. First, the node input features can be encoded through a linear layer (e.g., a layer of the value iteration graph neural network, etc.) to serve initial features for the value iteration network X₍₀₎=XW_{enc}+b_{enc}. (3). At each planning iteration t, the following iterative update can be performed through a long-short term memory layer (e.g., of the graph network, etc.) with an attention module across neighboring nodes:

$$\text{?} = {X}^{( k )} + LSTM ( Att ( {X}^{( k )} , A ) ; {H}^{( k )} ) , \qquad ( 4 )$$

$$\text{?} \text{indicates text missing or illegible when filed}$$

for t=1 . . . K and K is the total number of value iteration steps. H(t) can be the hidden state of the LSTM, which contains one state vector per node.

At (504), the method 500 can include navigating to a first segment of the transportation network based at least in part on the first plurality of node values. More particularly, the autonomous vehicle can select a node (e.g., a transportation network segment, etc.) that has the highest value, and subsequently navigate to that node. In some implementations, the navigation of the autonomous vehicle computing system to the first segment of the transportation network can be based at least in part on the first plurality of node values. More particularly, the plurality of nodes can be masked (e.g., obscured to the value iteration graph neural network, etc.) based on the respectively associated first plurality of node values. Based on the masked nodes, the computing system can generate a subset of nodes from the plurality of nodes. Further, the computing system can determine an optimal node of the subset of nodes based on the first plurality of node values.

As an example, the nodes can be masked based on a threshold value (e.g., a value threshold based on a gain associated with traversing the node, etc.). As another example, the nodes can be masked based on a number of times the segment of the transportation network corresponding to the node has been traversed. As yet another example, the nodes can be masked based on a distance from the node and/or characteristics of the autonomous vehicle (e.g., fuel level of the vehicle, a seating configuration of the vehicle, a current operating mode of the vehicle, a service level associated with the vehicle, etc.). It should be noted that it some implementations, navigating the vehicle to a node in the transportation network can include traversing one or more other nodes. As an example, navigating the vehicle to a third node may include traversing a first and second node to arrive at the third node.

At 506, the method 500 can include receiving, from one or more remote autonomous vehicle computing systems, one or more incoming communication vectors. The incoming communication vectors can include data that describes local observations from one or more remote autonomous vehicle computing systems. As an example, the incoming communication vector(s) may include node features that describe heavy traffic in one node (e.g., transportation segment). As another example, the incoming communication vector(s) may indicate that adverse weather conditions are present at one node.

At 508, the method 500 can include inputting the incoming communication vectors and the plurality of updated node feature vectors to the value iteration graph neural network. By doing so, the computing system can obtain a second plurality of updated node feature vectors and a second plurality of node values. In some implementations, the autonomous vehicle computing system can use a machine-learned attention aggregation layer to process the incoming communication vectors. More particularly, a machine-learned attention aggregation layer of the value iteration graph neural network can be used to generate an aggregated incoming communication vector based on attentional actor weights associated with each of the one or more remote autonomous vehicle computing systems. The one or more communication vectors can be aggregated such that the aggregated communication vector provides scalar node values for each node of the value iteration graph neural network. In such fashion, the aggregated incoming communication vector can easily facilitate updating of the nodes.

In some implementations, the communication vectors can each include one or more feature vector values and a key value. The machine-learned aggregation layer of the value iteration graph neural network can be configured to transform each of the one or more incoming communication vectors into a respective query vector and value vector. Further, the machine-learned aggregation layer can aggregate the one or more incoming communication vectors based on the respective query vectors, value vectors, and key values of the one or more incoming communication vectors. In such fashion, the attentional weights can be used to aggregate the incoming communication vectors.

Formally, as an example, agent i, given that Cᵢₙ ∈R^{L×nd} can represent the messages from other agents concatenated together (e.g., aggregated incoming communication vectors, etc.), where L is the number of agents, n is the number of nodes and d is the features dimension. Communication vectors are transformed to produce a query and a value vector:

$$\text{?} = \text{?} + \text{?} \qquad ( 12 )$$

$$\text{?} = \text{?} + \text{?} \qquad ( 13 )$$

$$\text{?} \text{indicates text missing or illegible when filed}$$

Further, the incoming communication vector last outputted by this given agent can also be called upon to produce a key vector:

$${k}_{t , comm} = {C}_{in , t} , {W}_{k , comm} + {b}_{k , comm} . \qquad ( 14 )$$

In some implementations, the key vector can be similarly dotted with the query GC vectors from all other agents to form a learned linear combination of the communication vectors from all the other agents. These, in some implementations, can be the communication features for input to the value iteration graph neural network. The aggregated communication (e.g., the aggregated second communication vector) can be denoted as Uᵢ:

$$\text{?} = softmax ( \text{?} ) \text{?} \qquad ( 15 )$$

$$\text{?} = \text{?} \qquad ( 16 )$$

$$\text{?} \text{indicates text missing or illegible when filed}$$

Uᵢ can, in some implementations, then be updated as part of X as the node feature inputs to the value iteration module for the next step planning.

In some implementations, the aggregated incoming vectors can be input into the value iteration graph neural network to obtain the second updated node feature vectors and the second plurality of node values. In some implementations, the value iteration graph neural network can continue to iterate the attention LSTM module for K iterations and use a linear layer to project the features into a scalar value function for each node on the graph. The value of all nodes can be masked out if the nodes no longer need to be visited since they have been fully mapped (e.g., the nodes have been traversed a certain number of times). After masking, a softmax can be performed over all remaining nodes to get the action probabilities:

$$\text{?} = softmax ( {X}^{( K )} \text{?} + \text{?} ) \text{?}$$

$$\text{?} \text{indicates text missing or illegible when filed}$$

At 510, the method 500 can include navigating the vehicle to a second segment of the transportation network based at least in part on the second plurality of node values. More particularly, in some implementations, the autonomous vehicle computing system can select a node with a preferred value (e.g., a value over a threshold, a highest value, a highest non-masked value, etc.) and navigate the vehicle to the node. The navigation of the vehicle can be performed as described with reference to step 504 of method 500.

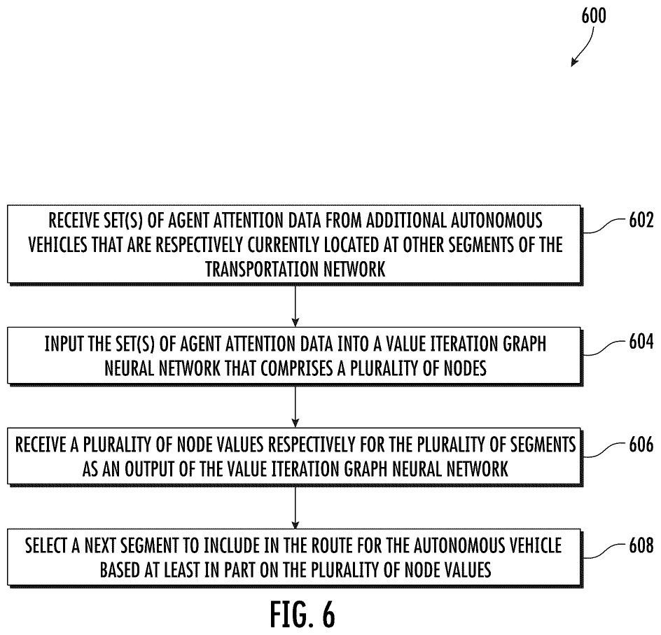

FIG. 6 depicts a flowchart for selecting an optimal transportation segment node based on incoming communication vectors according to example embodiments of the present disclosure. One or more portion(s) of the method 600 can be implemented by a computing system that includes one or more computing devices such as, for example, the computing systems described with reference to the other figures (e.g., the vehicle computing system 112, the autonomy computing system 120, etc.). Each respective portion of the method actors can be performed by any (or any combination) of one or more computing devices. Moreover, one or more portion(s) of the method actors can be implemented as an algorithm on the hardware components of the device(s) described herein (e.g., as in FIGS. 1-4), and/or on a training computing system accessible by a network. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method actors can be performed additionally, or alternatively, by other systems.

At 602, the method 600 can include receive sets of agent attention data from additional autonomous vehicles that are respectively currently located at other segments of the transportation network. The additional autonomous vehicles, when respectively currently located at other segments of the transportation network, can collect local observational data associated with the transportation segment of the transportation network that they are traversing. As an example, an additional autonomous vehicle can observe features of a node (e.g., a transportation segment) and locally update node values of a graph neural network onboard the autonomous vehicle.

It should be noted that, in some implementations, the agent attention data can be identical to the incoming communication vectors of FIG. 5. More particularly, the agent attention data from an additional autonomous vehicle can encode the same information as an incoming communication vector (e.g., local observation, node values, node feature(s), etc.). Alternatively, in some implementations, the agent attention data can be different than the incoming communication vectors, and as such can include different information than the incoming communication vectors. As an example, the agent attention data may include the encoded data of the incoming communication vectors while additionally including some specific attentional weight data regarding one or more nodes.

Based on the updated node values of the updated graph neural network, the additional autonomous vehicle can generate agent attention data that associates attention (e.g., attentional weights, etc.) with various nodes of the map graph of the additional autonomous vehicle. Additionally, or alternatively in some implementations, the agent attention data can be or otherwise include agent attentional data collated from other autonomous vehicles besides the additional autonomous vehicle. In such fashion, the additional autonomous vehicle agent attention data can be at least in part reflective of the agent attention data previously received by the additional autonomous vehicle.

At 604, the method can include inputting the set(s) of agent attention data into a value iteration graph neural network that comprises a plurality of nodes. More particularly, the autonomous vehicle computing system can input the set of agent attention data into the value iteration graph neural network. The value iteration graph neural network can include a plurality of nodes that respectively correspond to the plurality of segments in the transportation network. Each node of the value iteration graph neural network can be configured to receive the attention data associated with the corresponding segment. As an example, a first node of the value iteration graph neural network can receive three sets of agent attention data from three additional autonomous vehicles. The node value associated with the first node can be based at least in part on the three sets of agent attention data. The specific utilization of agent attention data can be implemented as described in detail with regards to FIG. 4.

In some implementations, inputting the set of agent attention data can include determining a set of fused attention data based at least in part on the one or more sets of agent attention data and an adjacency matrix that describes distances between the plurality of segments of the transportation network. Determining the set of fused attention data can be based on the agent attention data and an adjacency matrix that describes distances between the plurality of segments of the transportation network. After determining the set of fused attention data, the fused attention data can be input into the value iteration graph neural network.

At 606, the method 600 can include receiving a plurality of node values (e.g., scalar node values, etc.) respectively for the plurality of segments as an output of the value iteration graph neural network. More particularly, the node values can be generated based on the received set(s) of agent attention data and the current node feature vector(s) associated with each of the nodes. As an example, the values stored in the node feature vector(s) can be utilized to generate a node value for each node, which can then be modified based on the set(s) of agent attention data. As another example, the current node feature vectors for each node can be modified based on the received set(s) of agent attention data, and the node feature vectors can subsequently be utilized to generate a node value for each node. As yet another example, the value graph iteration neural network can store a set of attention data for each node alongside node feature vectors for each node, and both the node feature vectors and the agent attention data for each node can be utilized to generate node values for each node.

In some implementations, the set(s) of agent attention data can each include one or more feature vector values and a key value. The machine-learned aggregation layer of the value iteration graph neural network can be configured to transform each of the one or more incoming sets of agent attention data into a respective query vector and value vector. Further, the machine-learned aggregation layer can aggregate the one or more sets of agent attention data based on the respective query vectors, value vectors, and key values of the one or more sets of agent attention data. In such fashion, the attentional weights can be used to aggregate the sets of agent attention data.

At 608, the method 600 can include selecting a next segment to include in the route for the autonomous vehicle based at least in part on the plurality of node values. More particularly, the vehicle can determine an optimal node based on the value of each node. As an example, the optimal node can be the node with the highest associated node value. As another example, the optimal node can be the node with the highest associated node value within a certain radius. The determination of the optimal node can be determined based on any arbitrary criteria. The autonomous vehicle can, after determining the optimal node, select the transportation segment that corresponds to the node and include the transportation segment in the route of the autonomous vehicle. As such, the autonomous vehicle can navigate to the transportation segment after adding the segment to the route of the autonomous vehicle.

In some implementations, one or more nodes of the plurality of nodes can be masked (e.g., obscured to the value iteration graph neural network, etc.) based on the respectively associated received plurality of node values. Based on the masked nodes, the computing system can generate a subset of nodes from the plurality of nodes. Further, the computing system can determine an optimal node of the subset of nodes based on the first plurality of node values. The specific utilization of agent attention data to generate the plurality of node values using the value iteration graph neural network can be implemented as described in detail with regards to FIG. 4.

As an example, the nodes can be masked based on a threshold value (e.g., a value threshold based on a gain associated with traversing the node, etc.). As another example, the nodes can be masked based on a number of times the segment of the transportation network corresponding to the node has been traversed. As yet another example, the nodes can be masked based on a distance from the node and/or characteristics of the autonomous vehicle (e.g., fuel level of the vehicle, a seating configuration of the vehicle, a current operating mode of the vehicle, a service level associated with the vehicle, etc.).

In some implementations, the method can further include controlling, by the autonomous vehicle computing system, the autonomous vehicle to traverse a current segment of the transportation network to reach the selected next segment of the transportation network. As an example, the autonomous vehicle may be currently located on a first segment (e.g., a street segment, etc.) of the transportation network. The selected transportation segment can be adjacent to the first segment. The autonomous vehicle can traverse the first segment to reach the selected segment.

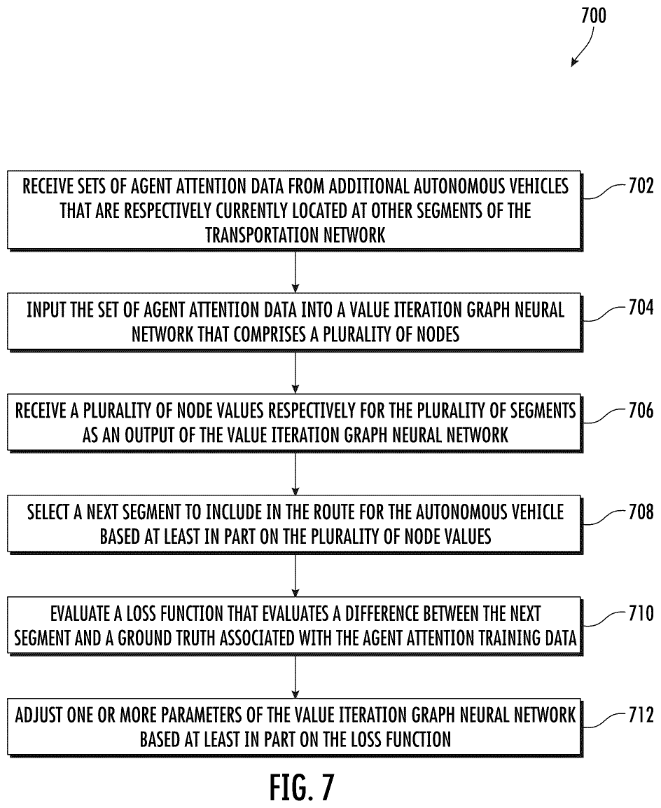

FIG. 7 depicts a flowchart for training a value iteration graph neural network according to example embodiments of the present disclosure. One or more portion(s) of the method 700 can be implemented by a computing system that includes one or more computing devices such as, for example, the computing systems described with reference to the other figures (e.g., the vehicle computing system 112, the autonomy computing system 120, etc.). Each respective portion of the method actors can be performed by any (or any combination) of one or more computing devices. Moreover, one or more portion(s) of the method actors can be implemented as an algorithm on the hardware components of the device(s) described herein (e.g., as in FIGS. 1-4), and/or on a training computing system accessible by a network. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method actors can be performed additionally, or alternatively, by other systems.

The method 700 can include steps 702, 704, 706, and 708 corresponding with 602, 604, 606, and 608 described above with reference to FIG. 6.

The method 700 can further include, at 710, evaluating a loss function that evaluates a difference between the next segment and a ground truth associated with the agent attention training data. More particularly, the set(s) of agent attention data received by the autonomous vehicle can be set(s) training data with associated ground truth(s). Based on the ground truth associated with the training data, the loss function can evaluate a difference between the ground truth (e.g., an optimal routing behavior, etc.) and the next segment selected by the computing system.

As an example, the ground truth may be associated with expert-specific routing behavior. For example, the ground truth routing behavior may have been selected by a separate algorithm designed to determine a most optimal overall segment selection based on fully observed environment data (e.g., an LKH3 solver with global information, etc.). In this manner, the loss function can evaluate the difference using imitation learning. Formally, in some implementations, the expert-specific routing behavior (e.g., imitation learning) can be used to train the value graph iteration neural network in an end-to-end fashion. As an example, to generate the ground-truth a*that the imitation learning seeks to imitate, an LKH3 solver can be provided with global information about each problem to solve as a fully observed environment. Based on the ground truth past trajectory, each agent can try to predict the next move a, and the agents can be trained using “teacher-forcing” by minimizing the cross entropy loss for each action, summing across the rollout. The loss of this training can, for example, be averaged across a mini-batch:

$$L = 𝔼 [ - \text{?} log π ( \text{?} ) ] , \qquad ( 17 )$$

$$\text{?} \text{indicates text missing or illegible when filed}$$

wherein π(a;s) can denotes the probability of taking action a given state s.

As another example, the method ground truth associated with the agent attention data can include an optimal local segment selection. The loss function can evaluate a difference between the next segment selected by the computing system and the optimal local segment selection (e.g., reinforcement learning, etc.). More particularly, reinforcement learning can be utilized to train the network (e.g., using episodic reinforcement learning, etc.), and can set the negative total cost of the fully rolled out traversal to be the reward function (e.g., normalized across a mini-batch, etc.). As an example, the reinforcement learning can be utilized as so:

$$r = - \text{?} \text{?} = ( r - \text{?} ) / \text{?} \qquad ( 18 )$$

$$L = \text{?} , ∇ L = \text{?} [ \text{?} ∇ log \text{?} ( \text{?} ) ] \text{?} \qquad ( 19 )$$

$$\text{?} \text{indicates text missing or illegible when filed}$$

The method 700 can further include, at 710, adjusting one or more parameters of the value iteration graph neural network based at least in part on the loss function. For example, the difference evaluated by the loss function can be sequentially back-propagated through the layers of the value iteration graph neural network to train parameters in one or more layers of the value iteration graph neural network. A gradient of the loss function can be calculated to determine an adjustment to the parameter(s) to reduce the difference evaluated by the loss function and to train the value iteration graph neural network.

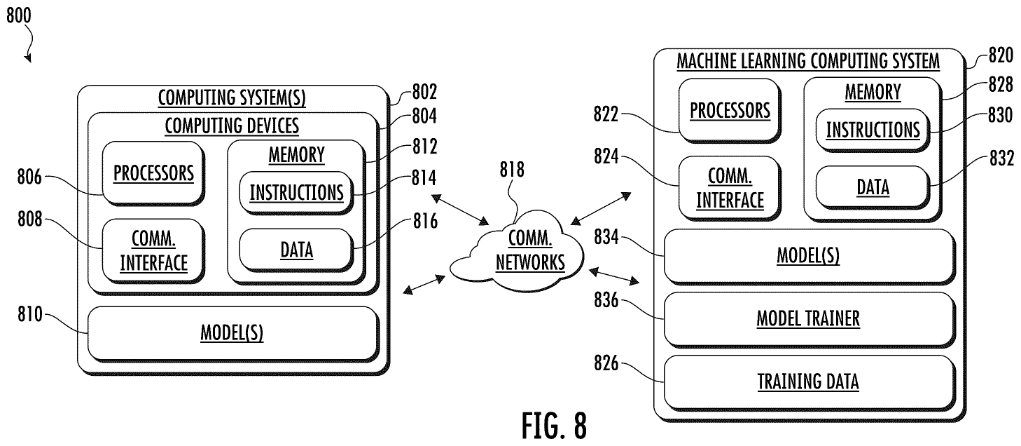

FIG. 800 depicts example system components of an example system 800 according to example implementations of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include computing system(s) 802 and a machine learning computing system 820 that are communicatively coupled over one or more network(s) 818. As described herein, the computing system(s) 802 can be implemented onboard a vehicle (e.g., as a portion of a vehicle computing system 112) and/or can be remote from a vehicle (e.g., as a computing system for a remote autonomous vehicle). In either case, a vehicle computing system 112 can utilize the operations and model(s) of the computing system(s) 802 (e.g., locally, via wireless network communication, etc.).

The computing system(s) 802 can include one or computing device(s) 804. The computing device(s) 804 of the computing system(s) 802 can include processor(s) 806 and a memory 812. The one or more processor(s) 806 can be any suitable processing device (e.g., a processor core, a microprocessor, an ASIC, a FPGA, a controller, a microcontroller, etc.) and can be one processor or a plurality of processors that are operatively connected. The memory 812 can include one or more non-transitory computer-readable storage media, such as RAM, ROM, EEPROM, EPROM, one or more memory devices, flash memory devices, etc., and/or combinations thereof.

The memory 812 can store information that can be obtained by the one or more processor(s) 806. For instance, the memory 812 (e.g., one or more non-transitory computer-readable storage mediums, memory devices, etc.) can include computer-readable instructions 814 that can be executed by the one or more processors 806. The instructions 814 can be software written in any suitable programming language or can be implemented in hardware. Additionally, or alternatively, the instructions 814 can be executed in logically and/or virtually separate threads on processor(s) 806.

For example, the memory 812 can store instructions 814 that when executed by the one or more processors 806 cause the one or more processors 806 (e.g., of the computing system(s) 802) to perform operations such as any of the operations and functions of the computing system(s) 802 and/or for which the computing system(s) 802 is configured, as described herein, the operations for selecting transportation segments (e.g., one or more portions of method 500), the operations for training a model to iteratively update node values (e.g., one or more portions of method 700), the operations and functions of any of the models described herein, and/or for which the models are configured and/or any other operations and functions for the computing system(s) 802, as described herein.

The memory 812 can store data 816 that can be obtained (e.g., received, accessed, written, manipulated, generated, created, stored, etc.). The data 816 can include, for instance, sensor data, local observational data, incoming communication vector(s), outgoing communication vector(s), node feature vector(s), node value(s), data indicative of machine-learned model(s) (e.g., the value iteration graph neural network), and/or other data/information described herein. In some implementations, the computing device(s) 804 can obtain data from one or more memories that are remote from the computing system(s) 802.

The computing device(s) 804 can also include a communication interface 808 used to communicate with one or more other system(s) (e.g., other systems onboard and/or remote from a vehicle, the other systems of FIG. 1, other additional and remote autonomous vehicle computing systems, etc.). The communication interface 808 can include any circuits, components, software, etc. for communicating via one or more networks (e.g., 818). In some implementations, the communication interface 808 can include, for example, one or more of a communications controller, receiver, transceiver, transmitter, port, conductors, software and/or hardware for communicating data/information.

According to an aspect of the present disclosure, the computing system(s) 802 can store or include one or more machine-learned models 818. As examples, the machine-learned model(s) 818 can be or can otherwise include the value iteration graph neural network 400. The machine-learned model(s) 818 can be or include neural networks (e.g., deep neural networks), support vector machines, decision trees, ensemble models, k-nearest neighbors models, Bayesian networks, or other types of models including linear models and/or non-linear models. Example neural networks include recurrent neural networks (e.g., long short-term memory recurrent neural network layers, etc.), feed-forward neural networks (e.g., convolutional neural networks, etc.), graph neural networks, attentional neural network layers, and/or other forms of neural networks.

In some implementations, the computing system(s) 802 can receive the one or more machine-learned models 818 (e.g., the value iteration graph neural network), from the machine learning computing system 820 over the network(s) 818 and can store the one or more machine-learned models 818 in the memory 812 of the computing system(s) 802. The computing system(s) 802 can use or otherwise implement the one or more machine-learned models 818 (e.g., by processor(s) 806). In particular, the computing system(s) 802 can implement the machine learned model(s) 818 to iteratively update node values in a graph neural network, as described herein.

The machine learning computing system 820 can include one or more processors 822 and a memory 828. The one or more processors 822 can be any suitable processing device (e.g., a processor core, a microprocessor, an ASIC, a FPGA, a controller, a microcontroller, etc.) and can be one processor or a plurality of processors that are operatively connected. The memory 828 can include one or more non-transitory computer-readable storage media, such as RAM, ROM, EEPROM, EPROM, one or more memory devices, flash memory devices, etc., and/or combinations thereof.

The memory 828 can store information that can be accessed by the one or more processors 822. For instance, the memory 828 (e.g., one or more non-transitory computer-readable storage mediums, memory devices, etc.) can store data 832 that can be obtained (e.g., generated, retrieved, received, accessed, written, manipulated, created, stored, etc.). In some implementations, the machine learning computing system 820 can obtain data from one or more memories that are remote from the machine learning computing system 820.

The memory 828 can also store computer-readable instructions 830 that can be executed by the one or more processors 822. The instructions 830 can be software written in any suitable programming language or can be implemented in hardware. Additionally, or alternatively, the instructions 830 can be executed in logically and/or virtually separate threads on processor(s) 822. The memory 828 can store the instructions 830 that when executed by the one or more processors 822 cause the one or more processors 822 to perform operations. The machine learning computing system 820 can include a communication interface 824, including devices and/or functions similar to that described with respect to the computing system(s) 802.

In some implementations, the machine learning computing system 820 can include one or more server computing devices. If the machine learning computing system 820 includes multiple server computing devices, such server computing devices can operate according to various computing architectures, including, for example, sequential computing architectures, parallel computing architectures, or some combination thereof.

In addition, or alternatively to the model(s) 810 at the computing system(s) 802, the machine learning computing system 820 can include one or more machine-learned model(s) 834. As examples, the machine-learned model(s) 834 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks (e.g., convolutional neural networks), recurrent neural networks (e.g., long short-term memory recurrent neural networks, etc.), and/or other forms of neural networks. The machine-learned models 834 can be similar to and/or the same as the machine-learned models 810, and/or any of the models discussed herein.

In some implementations, the machine learning computing system 820 and/or the computing system(s) 802 can train the machine-learned model(s) 810 and/or 834 through the use of a model trainer 685. The model trainer 836 can train the machine-learned models 810 and/or 834 using one or more training or learning algorithm(s), for example as described above with reference to FIG. 7. The model trainer 836 can perform backwards propagation of errors, supervised training techniques using a set of labeled training data, and/or unsupervised training techniques using a set of unlabeled training data. The model trainer 836 can perform a number of generalization techniques to improve the generalization capability of the models being trained. Generalization techniques include weight decays, dropouts, or other techniques.

The model trainer 836 can train a machine-learned model (e.g., 810 and/or 834) based on a set of training data 826. The training data 826 can include, for example, labeled datasets and/or unlabeled datasets.

In some implementations, the training data 826 can be taken from the same vehicle as that which utilizes the model(s) 810 and/or 834. Accordingly, the model(s) 810 and/or 834 can be trained to determine outputs in a manner that is tailored to that particular vehicle. Additionally, or alternatively, the training data 826 can be taken from one or more different vehicles than that which is utilizing the model(s) 810 and/or 834. The model trainer 685 can be implemented in hardware, firmware, and/or software controlling one or more processors. Additionally, or alternatively, other data sets can be used to train the model(s) (e.g., models 810 and/or 834) including, for example, publicly accessible datasets (e.g., labeled data sets, unlabeled data sets, etc.).

The network(s) 818 can be any type of network or combination of networks that allows for communication between devices. In some embodiments, the network(s) 818 can include one or more of a local area network, wide area network, the Internet, secure network, cellular network, mesh network, peer-to-peer communication link and/or some combination thereof and can include any number of wired or wireless links. Communication over the network(s) 818 can be accomplished, for instance, via a network interface using any type of protocol, protection scheme, encoding, format, packaging, etc.

FIG. 8 illustrates one example system 800 that can be used to implement the present disclosure. Other computing systems can be used as well. For example, in some implementations, the computing system(s) 802 can include the model trainer 836 and the training dataset 826. In such implementations, the machine-learned models 810 and 834 can be both trained and used locally at the computing system(s) 802 (e.g., at the vehicle 102).

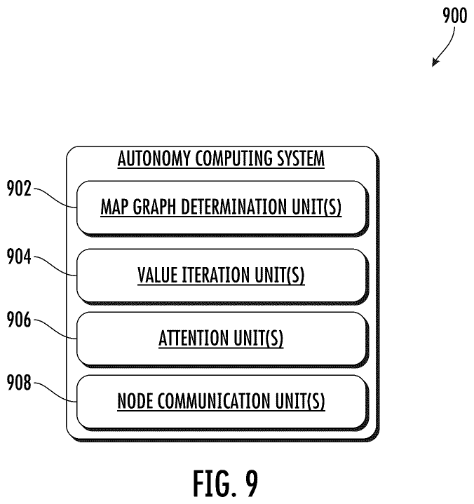

FIG. 9 depicts example system components of an example system according to example implementations of the present disclosure. Various means can be configured to perform the methods and processes described herein. For example, a computing system 900 can include map graph determination unit(s) 902, value iteration unit(s) 904, attention unit(s) 906, node communication unit(s) 908, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to iteratively update node feature vectors of nodes of a map graph in a value iteration graph neural network. In some implementations, the means can be configured to receive and/or determine the initial node feature(s) and/or value(s) of node(s) in a map graph. The map graph determination unit(s) 902 is one example of a means for determining a map graph as described herein.

The means can be configured to access or otherwise iterate through a value iteration graph neural network to update node values. More particularly, in some implementations, the means can be configured to access or otherwise iterate through a value iteration graph neural network to update node values based on received incoming communication vectors. The incoming communication vectors can, in some implementations, include data that describes remote attentional weights, remote local observations, remote nodal values, and/or any other arbitrary information. The value iteration unit(s) 904 is one example of a means for iteration as described herein.

The means can be configured to determine attention (e.g., attentional weights, etc.) for nodes in the map graph. The means can be configured to determine this attentional output by utilizing a machine-learned attention encoding layer. The attention of each node can determine and/or influence the final node value associated with each node. The attention unit(s) 906 is one example of a means for determining an attentional output for each of the nodes in the map graph as described herein.

The means can be configured to generate outgoing communication vector(s) and communicate the outgoing communication vector(s) to additional autonomous vehicles traversing the map graph. The means can be configured to encode information associated with the value iteration graph neural network (e.g., node feature(s), node value(s), local observational data, etc.) into the outgoing communication vector(s). The node communication unit(s) 908 is one example of a means for performing the above operations.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method comprising:
obtaining, from a remote autonomous vehicle computing system, an incoming communication vector descriptive of a local environmental condition of a remote autonomous vehicle;
inputting the incoming communication vector into a value iteration graph neural network of an autonomous vehicle;
generating, by the value iteration graph neural network, transportation segment navigation instructions identifying a target transportation segment to navigate the autonomous vehicle to;
generating a motion plan through an environment of the autonomous vehicle; and
controlling the autonomous vehicle by one or more vehicle control systems based on the motion plan.

2. The computer-implemented method of claim 1, further comprising generating an outgoing communication vector descriptive of one or more node values of the value iteration graph neural network.

3. The computer-implemented method of claim 2, wherein the outgoing communication vector further comprises information included in the incoming communication vector.

4. The computer-implemented method of claim 2, wherein the remote autonomous vehicle comprises a second value iteration graph neural network configured to receive the outgoing communication vector.

5. The computer-implemented method of claim 1, further comprising:
obtaining, from a plurality of additional remote autonomous vehicle computing systems, a plurality of additional incoming communication vectors respectively descriptive of respective local environmental conditions of a plurality of additional remote autonomous vehicles respective to the plurality of additional remote autonomous vehicle computing systems; and
inputting the plurality of additional incoming communication vectors into the value iteration graph neural network.

6. The computer-implemented method of claim 5, further comprising:
aggregating, by a machine-learned aggregation layer, the incoming communication vector and the plurality of additional incoming communication vectors to generate an aggregated incoming communication vector; and
inputting the aggregated incoming communication vector into the value iteration graph neural network.

7. The computer-implemented method of claim 6, wherein the machine-learned aggregation layer comprises attentional actor weights respectively associated with the remote autonomous vehicle and respectively associated with the plurality of additional remote autonomous vehicles.

8. The computer-implemented method of claim 6, wherein the machine-learned aggregation layer comprises an adjacency matrix.

9. The computer-implemented method of claim 1, wherein the value iteration graph neural network comprises a map graph, the map graph comprising one or more nodes corresponding to one or more transportation segments of a transportation segment network.

10. The computer-implemented method of claim 9, wherein the autonomous vehicle is positioned at a first segment of the one or more transportation segments of the transportation segment network, and wherein the remote autonomous vehicle is positioned at a second segment of the one or more transportation segments of the transportation segment network.

11. The computer-implemented method of claim 1, further comprising:
evaluating a value function of a plurality of nodes of the value iteration graph neural network; and
identifying a node of the plurality of nodes of the value iteration graph neural network having a maximum value of the value function respective to the node.

12. The computer-implemented method of claim 1, further comprising updating, based on the incoming communication vector, the value iteration graph neural network.

13. The computer-implemented method of claim 12, further comprising updating the value iteration graph neural network based on observational data of the autonomous vehicle.

14. An autonomous vehicle (AV) computing system, comprising:
one or more processors; and
one or more tangible, non-transitory, computer-readable media that store instructions that are executable by the one or more processors to perform operations comprising:
obtaining, from a remote autonomous vehicle computing system, an incoming communication vector descriptive of a local environmental condition of a remote autonomous vehicle;
inputting the incoming communication vector into a value iteration graph neural network of an autonomous vehicle;
generating, by the value iteration graph neural network, transportation segment navigation instructions identifying a target transportation segment to navigate the autonomous vehicle to;
generating a motion plan through an environment of the autonomous vehicle; and
controlling the autonomous vehicle by one or more vehicle control systems based on the motion plan.

15. The AV computing system of claim 14, wherein the operations further comprise generating an outgoing communication vector descriptive of one or more node values of the value iteration graph neural network.

16. The AV computing system of claim 14, wherein the operations further comprise:
obtaining, from a plurality of additional remote autonomous vehicle computing systems, a plurality of additional incoming communication vectors respectively descriptive of respective local environmental conditions of a plurality of additional remote autonomous vehicles respective to the plurality of additional remote autonomous vehicle computing systems; and
inputting the plurality of additional incoming communication vectors into the value iteration graph neural network.

17. The AV computing system of claim 16, wherein the operations further comprise:
aggregating, by a machine-learned aggregation layer, the incoming communication vector and the plurality of additional incoming communication vectors to generate an aggregated incoming communication vector; and
inputting the aggregated incoming communication vector into the value iteration graph neural network.

18. The AV computing system of claim 14, wherein the value iteration graph neural network comprises a map graph, the map graph comprising one or more nodes corresponding to one or more transportation segments of a transportation segment network.

19. The AV computing system of claim 14, wherein the operations further comprise updating, based on the incoming communication vector, the value iteration graph neural network.

20. An autonomous vehicle, comprising:
one or more processors; and
one or more tangible, non-transitory, computer-readable media that store instructions that are executable by the one or more processors to perform operations comprising:
obtaining, from a remote autonomous vehicle computing system, an incoming communication vector descriptive of a local environmental condition of a remote autonomous vehicle;
inputting the incoming communication vector into a graph neural network structured to update node feature vectors of a plurality of nodes that respectively correspond to a plurality of segments of a transportation network and to select, based on the updated node feature vectors, a target transportation segment of the plurality of segments;
generating, by the graph neural network, transportation segment navigation instructions identifying the target transportation segment to navigate the autonomous vehicle to;
generating a motion plan through an environment of the autonomous vehicle; and
controlling the autonomous vehicle by one or more vehicle control systems based on the motion plan.
